(19) United States
(12) Patent Application Publication
(10) Pub. No.: US 2025/0287457 A1
(43) Pub. Date: Sep. 11, 2025

(54) METHODS AND APPARATUSES FOR DISCONTINUOUS RECEPTION WITH ACTIVATION INDICATION IN SIDELINK

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Changlong XU, Beijing (CN); Shaozhen GUO, Beijing (CN); Luanxia YANG, Beijing (CN); Hao XU, Beijing (CN)

(21) Appl. No.: 19/105,016

(22) PCT Filed: Oct. 21, 2022
(86) PCT No.: PCT/CN2022/126589

§ 371 Date: Feb. 19, 2025

(51) Int. Cl. H04W 76/28; H04W 72/25; H04W 74/0816; H04W 92/18

(52) U.S. Cl. CPC H04W 76/28; H04W 72/25; H04W 74/0816; H04W 92/18

(57) ABSTRACT

A method of wireless communication at a first UE is disclosed herein. The method includes transmitting, to a second UE, an activation indication associated with a DRX cycle of the second UE, where the activation indication indicates a second set of resources utilized for the DRX cycle of the second UE, where a first set of resources is different from the second set of resources. The method includes transmitting, to the second UE based on the activation indication, SL data via the first set of resources or the second set of resources.

### TECHNICAL FIELD

The present disclosure relates generally to communication systems, and more particularly, to sidelink communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a first user equipment (UE) are provided. The apparatus includes a memory and at least one processor coupled to the memory and, based at least in part on information stored in the memory, the at least one processor is configured to: transmit, to a second UE, an activation indication associated with a discontinuous reception (DRX) cycle of the second UE, where the activation indication indicates a second set of resources utilized for the DRX cycle of the second UE, where a first set of resources is different from the second set of resources; and transmit, to the second UE based on the activation indication, sidelink (SL) data via the first set of resources or the second set of resources.

In an aspect of the disclosure, a method, a computer-readable medium, and an apparatus for wireless communication at a second user equipment (UE) are provided. The apparatus includes a memory and at least one processor coupled to the memory and, based at least in part on information stored in the memory, the at least one processor is configured to: receive, from a first UE, an activation indication associated with a discontinuous reception (DRX) cycle of the second UE, where the activation indication indicates a second set of resources utilized for the DRX cycle of the second UE, where a first set of resources are different from the second set of resources; and receive, from the first UE based on the activation indication, sidelink (SL) data via the first set of resources or the second set of resources.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a discontinuous reception (DRX) cycle.

FIG. 5 is a diagram illustrating example communications between a first base station, a transmitting UE (Tx UE), a receiving UE (Rx UE), and a second base station for a sidelink DRX configuration.

FIG. 6 is a diagram illustrating example communications between a Tx UE and a Rx UE for a sidelink DRX configuration.

FIG. 7 is a diagram illustrating various example aspects of listen-before-talk (LBT) procedures.

FIG. 8 is a diagram illustrating examples of first stage sidelink control information (SCI-1) and second stage sidelink control information (SCI-2).

FIG. 9 is a diagram illustrating an example of a DRX on-duration and an extended DRX on-duration.

FIG. 10 is a diagram illustrating examples of an offset, a duration, a cycle length, and a cycle timer associated with an extended DRX on-duration.

FIG. 11 is a diagram illustrating examples of extended DRX on-duration activation commands.

FIG. 12 is a diagram illustrating an example of an extended DRX on-duration activation command transmitted via a mini-slot transmission.

FIG. 13 is a diagram illustrating an example of an extended DRX on-duration activation command transmitted via short control signaling.

FIG. 14 is a diagram illustrating an example of an extended DRX on-duration activation command transmitted via a contention exempt transmission.

FIG. 15 is a diagram illustrating an example of an extended DRX on-duration activation command transmitted via a physical shared feedback channel (PSFCH) transmission.

FIG. 16 is a diagram illustrating examples of indicating extended DRX on-durations for activation.

FIG. 17 is a diagram illustrating an example of indicating an extended DRX on-duration via a bitmap.

FIG. 18 is a diagram illustrating an example of determining an extended DRX on-duration based on a remaining DRX on-duration starting from a reception of an activation command.

FIG. 19 is a diagram illustrating example communications between a first UE and a second UE.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a diagram illustrating an example of a hardware implementation for an example apparatus.

FIG. 25 is a diagram illustrating an example of a hardware implementation for an example network entity.

### DETAILED DESCRIPTION

A first UE may be configured with a discontinuous reception (DRX) cycle in which the first UE may receive packets during a DRX on-duration and in which the first UE may periodically enter a power-saving mode when there is no intimation of packet arrival from a base station. The first UE may also utilize a DRX cycle for sidelink communications with a second UE. When a DRX cycle is utilized in sidelink, a Rx UE (e.g., the first UE) may apply a restriction such that resources are within the DRX on-duration. If none of the resources are within the DRX on-duration of the Rx UE, an implementation of the Rx UE may determine whether resources are added to the DRX on-duration. Furthermore, in sidelink unlicensed (SL-U) communications, a Tx UE (e.g., the second UE) may perform a LBT procedure prior to transmission. If the LBT procedure fails, the Tx UE may issue a resource reselection to the Rx UE or the Tx UE may use a retransmission occasion for an initial transmission. Resource selection based on UE implementation may suffer from interference and may increase a probability of a subsequent LBT failure. Additionally, frequent resource reselection and/or insufficient resources may impede throughput. Various technologies pertaining to enhancing a sidelink DRX cycle are described herein. In an example, a first UE transmits, to a second UE, an activation indication associated with a DRX cycle of the second UE, where the activation indication indicates a second set of resources (e.g., resources associated with an extension of the DRX on-duration of the second UE) utilized for the DRX cycle of the second UE, where a first set of resources (e.g., resources associated with a DRX on-duration of the second UE) is different from the second set of resources. The first UE transmits, to the second UE based on the activation indication, SL data via the first set of resources or the second set of resources. Vis-à-vis the activation indication, the above-described technologies may increase communications reliability between the first UE and the second UE. For instance, the activation indication may reduce occurrences of resource reselection at a MAC layer and/or may reduce use of retransmission occasions for initial transmissions. The activation indication may also reduce a probability of a LBT failure via reduced resource reselection.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (e.g., a gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

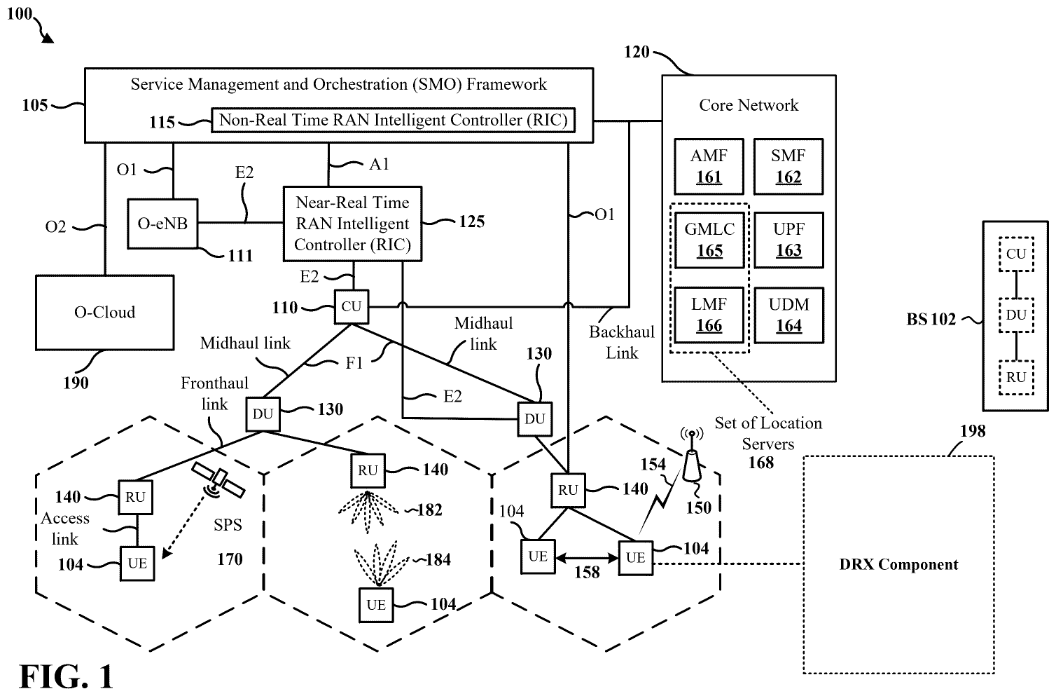

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a DRX component 198 that is configured to transmit, to a second UE, an activation indication associated with a DRX cycle of the second UE, where the activation indication indicates a second set of resources utilized for the DRX cycle of the second UE, where a first set of resources is different from the second set of resources; and transmit, to the second UE based on the activation indication, SL data via the first set of resources or the second set of resources. In certain aspects, the DRX component 198 is configured to receive, from a first UE, an activation indication associated with a DRX cycle of the second UE, where the activation indication indicates a second set of resources utilized for the DRX cycle of the second UE, where a first set of resources are different from the second set of resources; and receive, from the first UE based on the activation indication, SL data via the first set of resources or the second set of resources. Although the following description may be focused on 5G NR, the concepts described herein may be applicable to other similar areas, such as LTE, LTE-A, CDMA, GSM, and other wireless technologies.

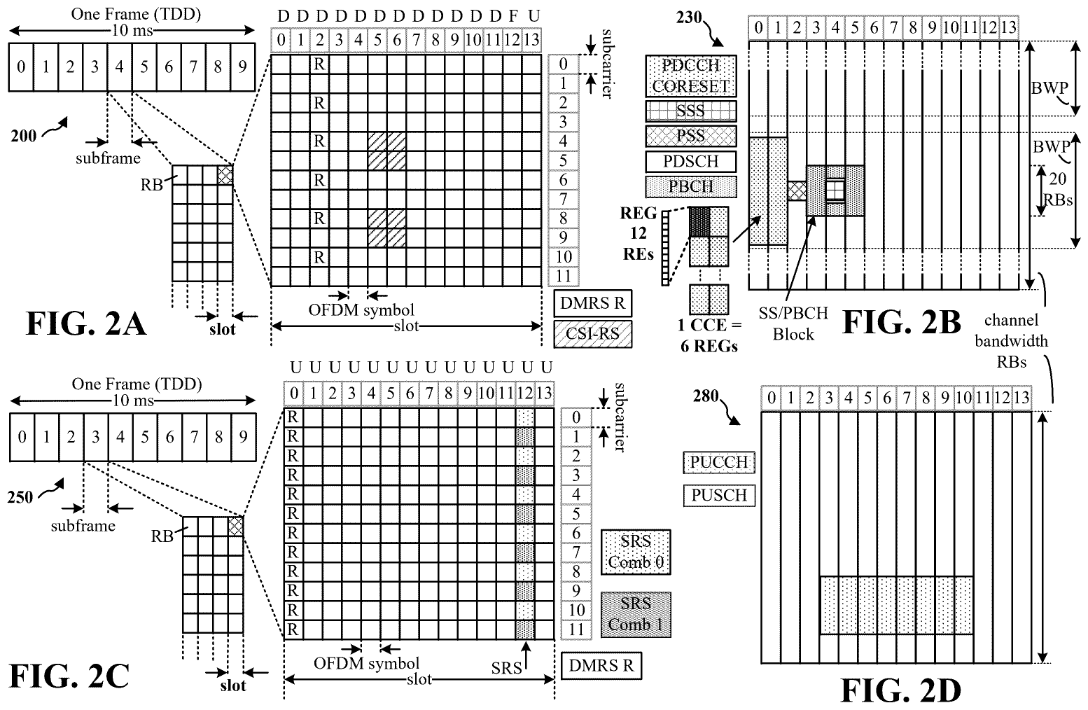

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

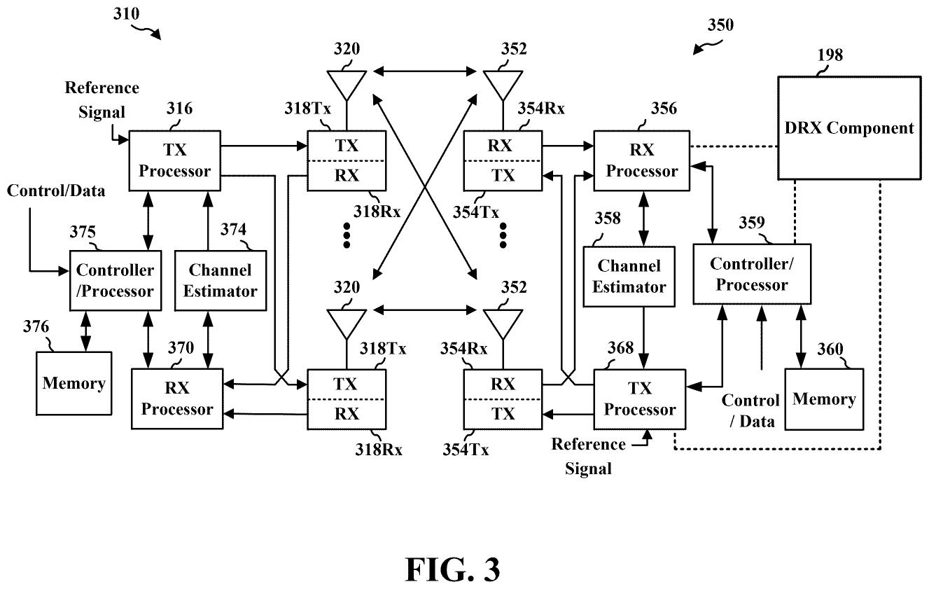

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the DRX component 198 of FIG. 1.

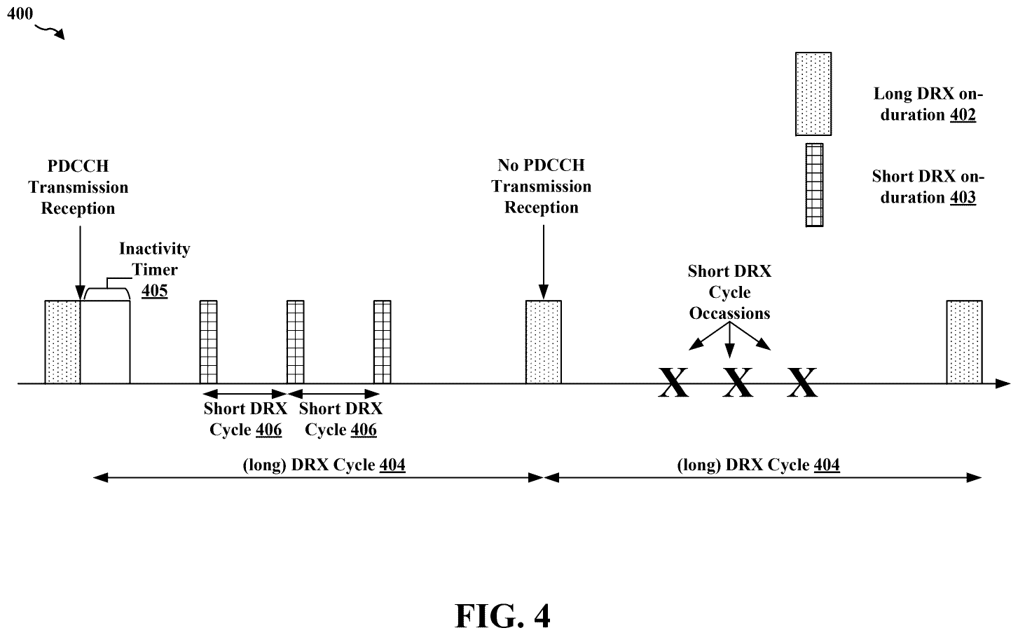

FIG. 4 is a diagram 400 illustrating an example of a DRX cycle. When a UE is configured with a DRX cycle, the UE may not continually monitor a PDCCH for a PDCCH transmission. A DRX cycle may be characterized by an on-duration and an inactivity timer. The on-duration may refer to a duration that a UE waits for after waking up to receive PDCCH transmissions. If the UE successfully decodes a PDCCH transmission during an on-duration, the UE may stay awake and start the inactivity timer. The inactivity timer may refer to a duration that the UE waits to successfully decode a PDCCH transmission from a last successful decoding of a prior PDCCH transmission. If the UE does not successfully decode a PDCCH transmission during the duration of the inactivity timer, the UE may be placed in a sleep state. The UE may restart the inactivity timer following a single successfully decoding of a PDCCH transmission. The UE may not restart the inactivity timer for a retransmission of a PDCCH transmission. If a SL UE is configured with a DRX cycle, a PDCCH providing SL grants may be sent to the UE during an active time of the UE.

A UE may be configured with a (long) DRX cycle 404. During a long DRX on-duration 402 of the (long) DRX cycle 404, the UE may monitor for data (e.g., downlink data, such as downlink control signaling, or sidelink data, such as sidelink control signaling). In an example, the UE may monitor a PDCCH or a PSCCH for transmissions during the long DRX on-duration 402. If the UE successfully decodes a transmission (e.g., a PDCCH transmission or a PSCCH transmission) during the long DRX on-duration 402, the UE may stay awake and start an inactivity timer 405 (e.g., specified in milliseconds). When the UE is not within the long DRX on-duration 402 of the (long) DRX cycle 404 and if the UE does not successfully decode a transmission during a duration associated with the inactivity timer 405, the UE may sleep with receiver circuitry turned off. This may allow for a reduction in power consumption of the UE. In an example, a relatively longer DRX cycle may enable a relatively greater power consumption reduction than a relatively shorter DRX cycle. The UE may also be configured with a short DRX cycle 406 in addition to the (long) DRX cycle 404. During a short DRX on-duration 403 of the short DRX cycle 406, a UE may monitor for a transmission (e.g., a PDCCH transmission or a PSCCH transmission). The short DRX cycle 406 may have a shorter duration than the (long) DRX cycle 404. In an example, the UE may follow the (long) DRX cycle 404 until the UE is scheduled for the short DRX cycle 406. In the example, the UE may follow the short DRX cycle 406 for a period of time (in addition to following the (long) DRX cycle 404). The (long) DRX cycle 404 may be associated with reduced power consumption; however, the (long) DRX cycle may be associated with increased latency for receiving data. When an inactivity timer expires (e.g., the inactivity timer 405), the short DRX cycle 406 may be activated. The short DRX cycle 406 may be associated with reduced latency for receiving data. The short DRX cycle 406 may be useful in voice over internet protocol (IP) related scenarios.

A UE may be configured with a connected mode DRX (C-DRX) mechanism that may enable a UE (e.g., a mobile UE) to periodically enter a power-saving mode (i.e., sleep mode). During the power-saving mode, the UE may turn off major circuits when there is no intimation of packet arrival. The UE may wake up (i.e., leave the sleep mode) to periodically check for packet arrival. To prevent data loss, the UE and a network may have a predefined agreement about a periodic transition of the UE between sleep states and non-sleep states (i.e., wake up states). In an example, the UE may receive DRX configuration parameters in a DL RRC configuration message sent by the network (e.g., via a base station, such as a gNB).

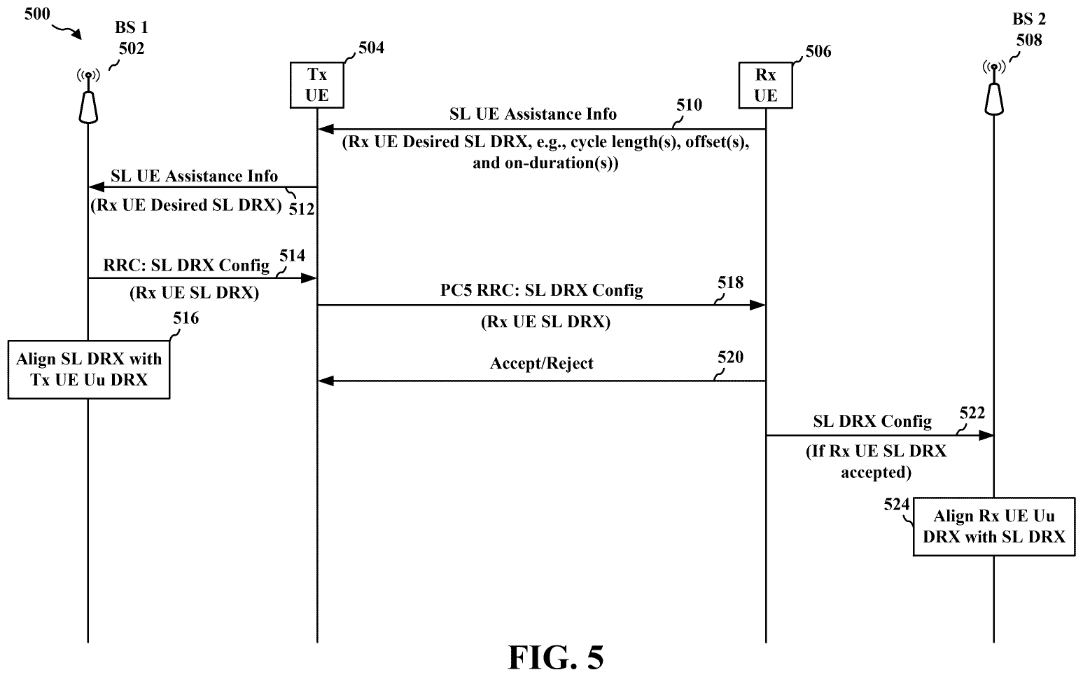

FIG. 5 is a diagram 500 illustrating example communications between a first base station 502, a Tx UE 504, a Rx UE 506, and a second base station 508 for a sidelink DRX configuration (e.g., a C-DRX sidelink configuration). The communications in the diagram 500 may be associated with a sidelink DRX configuration that is unicast, that is, negotiated between UEs. In an example, the Tx UE 504 and/or the Rx UE 506 may be in a RRC connected state. At 510, the Rx UE 506 may transmit sidelink (SL) UE assistance information to the Tx UE 504. The SL UE assistance information may include an indication of one or more DRX cycle lengths, one or more DRX cycle offsets, and one or more DRX on-durations. Stated differently, the SL UE assistance information may be a desired SL DRX configuration.

At 512, the Tx UE 504 may forward the SL UE assistance information to the first base station 502 (e.g., a first gNB). At 514, the first base station 502 may determine a SL DRX configuration for the Rx UE 506 and the first base station 502 may transmit a SL DRX configuration to the Tx UE 504. The first base station 502 may determine the SL DRX configuration for the Rx UE 506 based on the SL UE assistance information. In one aspect, at 516, the first base station 502 may align the SL DRX cycle with a DRX cycle of the Tx UE 504 (e.g., “align SL DRX with Tx UE UE-UTRAN (Uu) DRX”).

At 518, the Tx UE 504 may transmit the SL DRX configuration (i.e., a Rx UE SL DRX) to the Rx UE 506 via a PC-5 RRC message. At 520, the Rx UE 506 may transmit a message to the Tx UE 504 indicating whether the SL DRX configuration is accepted or rejected. At 522, if the SL DRX configuration is accepted by the Rx UE 506, the Rx UE 506 may transmit the SL DRX configuration to the second base station 508 (e.g., a second gNB). In one aspect, at 524, the second base station 508 may align a DRX cycle of the Rx UE 506 with the SL DRX cycle (e.g., “align Rx UE Uu DRX with SL DRX”).

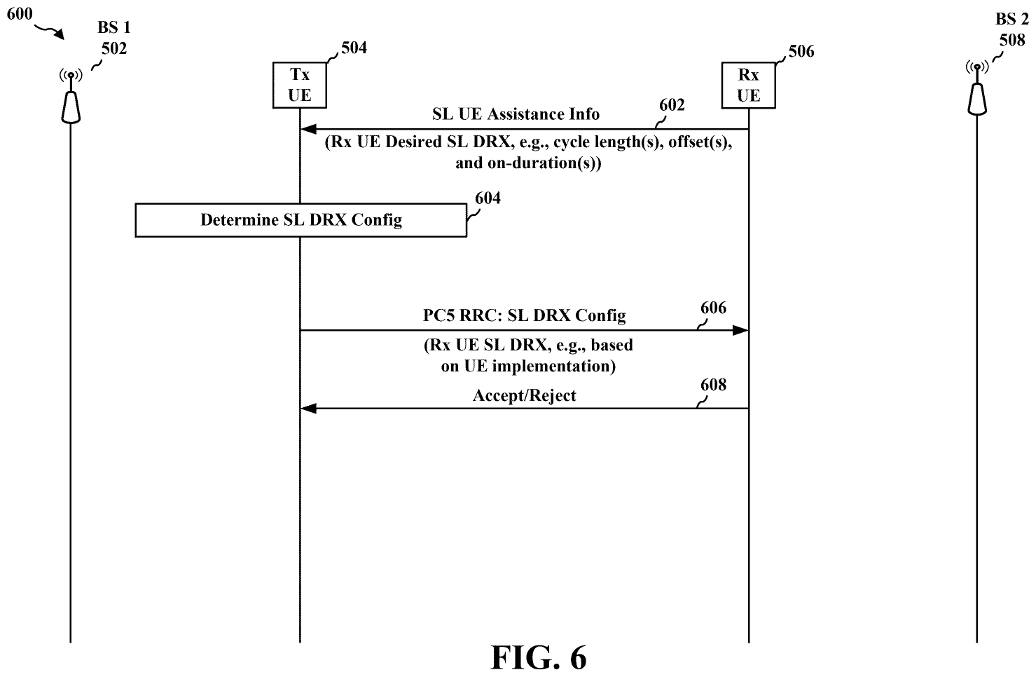

FIG. 6 is a diagram 600 illustrating example communications between the Tx UE 504 and the Rx UE 506 for a sidelink DRX configuration. The communications in the diagram 600 may be associated with a sidelink DRX configuration that is unicast, that is, negotiated between UEs. In an example, the Tx UE 504 and/or the Rx UE 506 may be in a RRC inactive state or a RRC idle state. In another example, the communications in the diagram 600 may be applicable when UEs are in coverage (IC) or out of coverage (OoC) of a base station.

At 602, the Rx UE 506 may transmit SL UE assistance information to the Tx UE 504. The SL UE assistance information may include an indication of one or more DRX cycle lengths, one or more DRX cycle offsets, and one or more DRX on-durations. Stated differently, the SL UE assistance information may be a desired SL DRX configuration. At 604, the Tx UE 504 may determine a SL DRX configuration for the Rx UE 506. The Tx UE 504 may determine the SL DRX configuration based on the SL UE assistance information. The Tx UE 504 may determine the SL DRX configuration based on an implementation of the Tx UE 504 and/or the Rx UE 506.

In an example, an implementation of the Rx UE 506 may be utilized to derive an inactivity timer associated with the SL DRX configuration. At 606, the Tx UE 504 may transmit the SL DRX configuration (i.e., a Rx UE SL DRX) to the Rx UE 506 via a PC-5 RRC message. At 608, the Rx UE 506 may transmit a message to the Tx UE 504 indicating whether the SL DRX configuration is accepted or rejected.

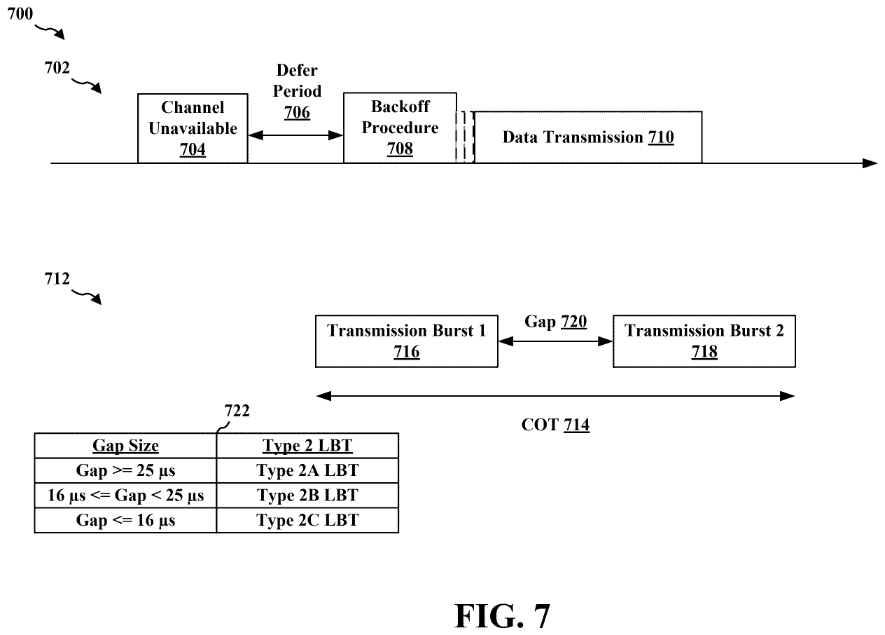

FIG. 7 is a diagram 700 illustrating various example aspects associated with listen-before-talk (LBT) procedures. The diagram 700 includes a first example 702 that depicts a LBT procedure. During the LBT procedure, a UE may refrain from transmitting data while a channel is unavailable 704, that is, the UE may monitor the channel and determine that the channel is unavailable based on the monitoring. The LBT procedure may be used for sidelink communications between UEs. The LBT procedure may be a Type 1 LBT procedure that may be used to initiate one or more transmission with the same channel occupancy time (COT).

When the UE determines that the channel is available for at least a defer period 706, the UE may initiate a backoff procedure 708. In an example, the defer period 706 may range from 16+9*n ms. In an example, n may be 1, 3, or 7 for downlink and n may be 2, 3, or 7 for uplink. In an example, n may be specified in a downlink channel access priority class (CAPC) table or an uplink CAPC table. The UE may determine that the channel is available if a received energy during the defer period is less than a threshold value. The backoff procedure 708 may include initializing a backoff counter with a random number within a contention window (CW). The random number may range from zero to the CW. The random number may represent a duration that the channel is to be available before data may be transmitted over the channel. The backoff counter may be decremented at certain intervals. Each time the backoff counter is decremented, the UE may determine whether or not the channel is idle for a time period (i.e., whether the channel is available). If the channel is idle, the backoff counter may be decremented again. If the channel is not idle, the UE may wait until the channel is idle before resuming the backoff counter. When the backoff counter reaches zero, data transmission 710 by the UE may occur.

The diagram 700 also includes a second example 712 that depicts an example of a COT 714. Following a successful dynamic or semi-static channel access procedure, a channel may be used during the COT 714. During the COT 714, one or more transmission bursts (e.g., for uplink or downlink) may be exchanged between devices (e.g., between UEs).

The second example 712 depicts a first transmission burst 716 and a second transmission burst 718 that may be separated by a gap 720. Depending on a size of the gap 720, a UE may utilize a different type of channel access procedure (e.g., a different type of a type 2 LBT procedure). The second example 712 depicts a table 722 that details gap sizes and corresponding type 2 LBT procedures. If the size of the gap 720 is greater than or equal to 25 μs, a device (e.g., a UE) may utilize a type 2A LBT procedure. In an example, a device (e.g., a base station, such as a gNB) may transmit a DL transmission immediately after sensing a channel to be idle for a sensing interval of 25 μs. If the size of the gap 720 is greater than or equal to 16 μs and less than 25 μs, the device may utilize a cyclic prefix (CP) extension to maintain a 16 μs gap and the device may utilize a type 2B LBT procedure. In an example, a device (e.g., a base station, such as a gNB) may transmit a DL transmission immediately after sensing a channel to be idle within a duration of 16 μs. If the size of the gap 720 is less than or equal to 16 μs, the device may utilize a type 2C LBT procedure. In an example, if a device (e.g., a base station, such as a gNB) follows a type 2C LBT procedure, the device may not sense the channel before transmission of a DL transmission. The DL transmission may have a duration that is less than or equal to 584 μs.

In an example, a type 1 LBT procedure may be performed prior to transmission of the first transmission burst 716. A type 2A, type 2B, or type 2C LBT procedure may be performed prior to transmission of the second transmission burst 718 based on a size of the gap 720. In an example, the first transmission burst 716 may be a downlink transmission and the second transmission burst 718 may be an uplink transmission. In another example, the first transmission burst 716 and the second transmission burst 718 may be communications exchanged between UEs in sidelink communications. Furthermore, the type 2A, type 2B, and type 2C LBT procedures may be used for sidelink communications between UEs.

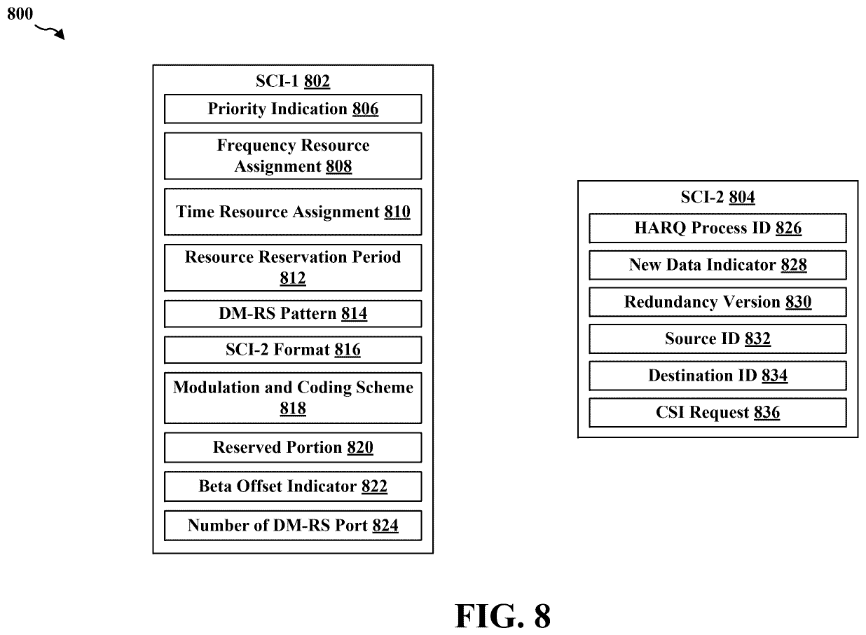

FIG. 8 is a diagram 800 illustrating examples of a SCI-1 802 and a SCI-2 804. The SCI-1 802 may be referred to as a first stage SCI and the SCI-2 804 may be referred to as a second stage SCI. The SCI-1 802 may also be referred to as “SCI format 1” and the SCI-2 804 may also be referred to as “SCI format 2.” In general, the SCI-1 802 may include information that may be used by a UE to decode information in the SCI-2 804.

The SCI-1 802 may be carried on a PSCCH that is associated with a PSSCH. The SCI-1 802 may include information for demodulation/detection of the PSSCH. The SCI-1 802 may include a priority indication 806. The SCI-1 802 may include an indication of a frequency resource assignment 808 for a UE. The SCI-1 802 may include an indication of a time resource assignment 810. The SCI-1 802 may include an indication of a resource reservation period 812. The SCI-1 802 may include an indication of a DM-RS pattern 814. The SCI-1 802 may include an indication of a SCI-2 format 816 for a to-be-received SCI-2 (e.g., the SCI-2 804). In an example, the SCI-2 804 may be in one of a plurality of formats and the SCI-2 format 816 may indicate such a format. The SCI-1 802 may include a modulation and coding scheme 818. The SCI-1 802 may include a reserved portion 820. The SCI-1 802 may include a beta offset indicator 822. The SCI-1 802 may include a number of a DM-RS port 824.

The SCI-2 804 may be carried on a PSSCH. The SCI-2 804 may include a HARQ process identifier (ID) 826. The SCI-2 804 may include a new data indicator 828. The SCI-2 804 may include an indication of a redundancy version 830. The SCI-2 804 may include a source ID 832 corresponding to a UE that is the source of the SCI-2 804 (i.e., a UE that transmitted the SCI-2 804). The SCI-2 804 may include a destination ID 834 corresponding to a UE (or a group of UEs) that is/are the intended destination of the SCI-2 804 (i.e., a UE that is to receive the SCI-2 804). The SCI-2 804 may include a channel state information (CSI) request 836.

As noted above, a UE may utilize a C-DRX cycle for sidelink communications in order to conserve power. When a physical layer is indicated within an active time of an Rx UE from a medium access control (MAC) layer for candidate resource selection, a restriction may be applied in a physical layer such that at least a subset of candidate resources reported to the MAC layer may be located within an indicated active time of the Rx UE. If the candidate resources are not within an active time of the Rx UE, the Rx UE may add at least one resource within the active time (e.g., based on an implementation of the Rx UE). In unlicensed band sidelink (SL-U), a UE may perform a LBT procedure before transmission. In an example, the UE may first select a set of resources (e.g., time and frequency resources) and the UE may then fail the LBT procedure, which may trigger a LBT failure at a MAC layer of the UE. The UE may handle the LBT failure in different manners. In a first example, the UE may handle the LBT failure by issuing a resource reselection at the MAC layer. In a second example, the UE may handle the LBT failure by using a retransmission occasion for an initial transmission. If C-DRX is used in SL-U, resources selected by a UE implementation may be affected by interference. As a result, a probability of a failure of a LBT procedure may be higher. Furthermore, frequent resource reselection and/or insufficient resources may impede throughput at the UE.

Various technologies pertaining to enhancing a sidelink DRX cycle are described herein. In an example, a first UE transmits, to a second UE, an activation indication associated with a DRX cycle of the second UE, where the activation indication indicates a second set of resources (e.g., resources associated with an extension of the DRX on-duration of the second UE) utilized for the DRX cycle of the second UE, where a first set of resources (e.g., resources associated with a DRX on-duration of the second UE) is different from the second set of resources. The first UE transmits, to the second UE based on the activation indication, SL data via the first set of resources or the second set of resources. Vis-à-vis the activation indication, the above-described technologies may increase communications reliability between the first UE and the second UE. For instance, the activation indication may reduce occurrences of resource reselection at a MAC layer and/or may reduce use of retransmission occasions for initial transmissions. The activation indication may also reduce a probability of a LBT failure via reduced resource reselection.

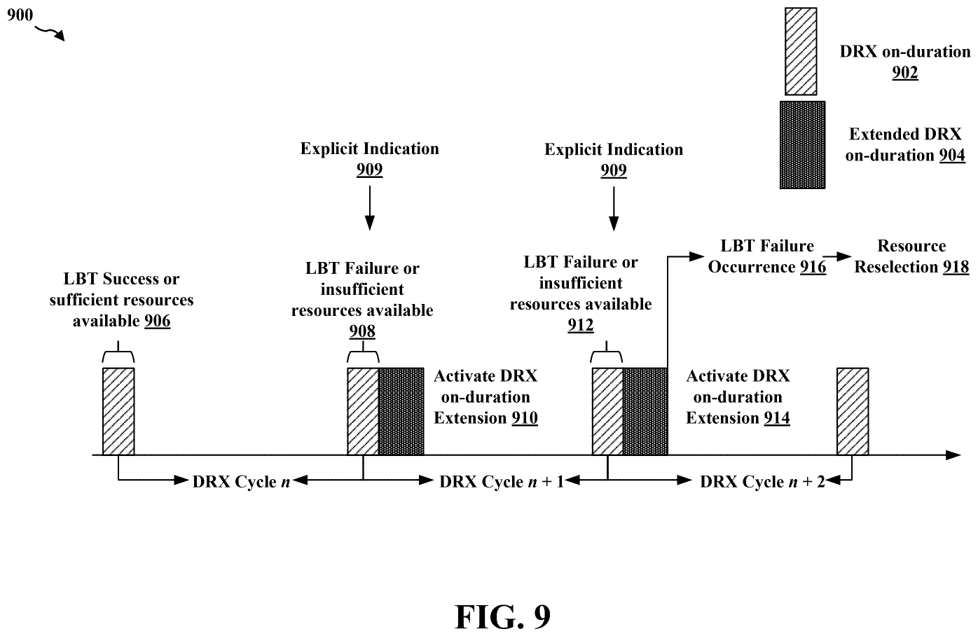

FIG. 9 is a diagram 900 illustrating an example of a DRX on-duration and an extended DRX on-duration. The diagram 900 depicts a DRX cycle n, a DRX cycle n+1, and a DRX cycle n+2, where n is an integer. A Tx UE may select a set of additional candidate resources within an extended DRX on-duration as an alternate in a resource selection procedure. The DRX on-duration extension may be activated when a Rx UE receives an activation command (i.e., an explicit indication) from a Tx UE during a DRX on-duration. If the Tx UE fails the LBT procedure or the Tx UE does not have sufficient resources for transmissions, the DRX on-duration extension may be activated via the activation command and the Tx UE may use the additional candidate resources to communicate with a Rx UE without utilizing a resource reselection. If the LBT procedure fails before the selected resource in the extended DRX on-duration, the Tx UE may trigger resource reselection.

As illustrated in the diagram 900, at 906, a Tx UE (e.g., the Tx UE 504) may pass a first LBT procedure (e.g., the LBT procedure described above in the description of FIG. 7) or the Tx UE may have sufficient resources for a transmission to a Rx UE (e.g., the Rx UE 506) during a DRX on-duration 902. In an example, the DRX on-duration 902 may correspond to the long DRX on-duration 402 described above.

At 908, the Tx UE may fail a second LBT procedure or the Tx UE may have insufficient resources for a transmission during the DRX on-duration 902. The Tx UE may transmit a first instance of an explicit indication 909 (e.g., an activation command) to the Rx UE which activates an extended DRX on-duration 904 at 910. The Rx UE and the Tx UE may communicate via resources associated with the extended DRX on-duration 904 without utilizing resource reselection.

In an example, at 912, the Tx UE may fail a third LBT procedure or the Tx UE may have insufficient resources for a transmission during the DRX on-duration 902. The Tx UE may transmit a second instance of an explicit indication 909 to the Rx UE which activates an extended DRX on-duration 904 at 914. In the example, at 916, during the extended DRX on-duration 904, the Tx UE may fail a fourth LBT procedure. In the example, at 918, the Tx UE may trigger resource reselection based on the failure of the fourth LBT procedure.

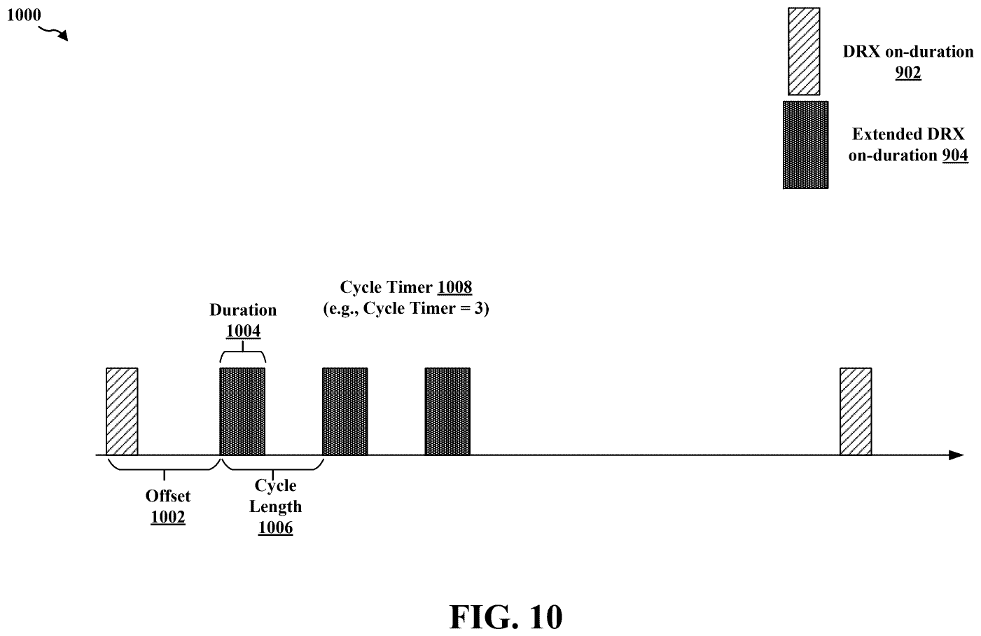

FIG. 10 is a diagram 1000 illustrating examples of an offset 1002, a duration 1004, a cycle length 1006, and a cycle timer 1008 associated with the extended DRX on-duration 904. The offset 1002 may refer to a time difference between a starting point of the extended DRX on-duration 904 and a starting point of the DRX on-duration 902. The duration 1004 may refer to an active time of the extended DRX on-duration 904. The cycle length 1006 may refer to a period of the extended DRX on-duration 904. The cycle timer 1008 may refer to a number of DRX-on duration extensions between two DRX on-durations. In an example, the cycle timer 1008 may be equal to three. Multiple DRX on-duration extensions may be associated with LBT diversity gain which may mitigate LBT failures.

A Tx UE (e.g., the Tx UE 504) may determine a configuration for the extended DRX on-duration 904 for a respective Rx UE (e.g., the Rx UE 506). The Tx UE may transmit the configuration for the extended DRX on-duration 904 via a PC-5 RRC message. The configuration may include an indication of the offset 1002, the duration 1004, the cycle length 1006, and the cycle timer 1008 associated with the extended DRX on-duration 904.

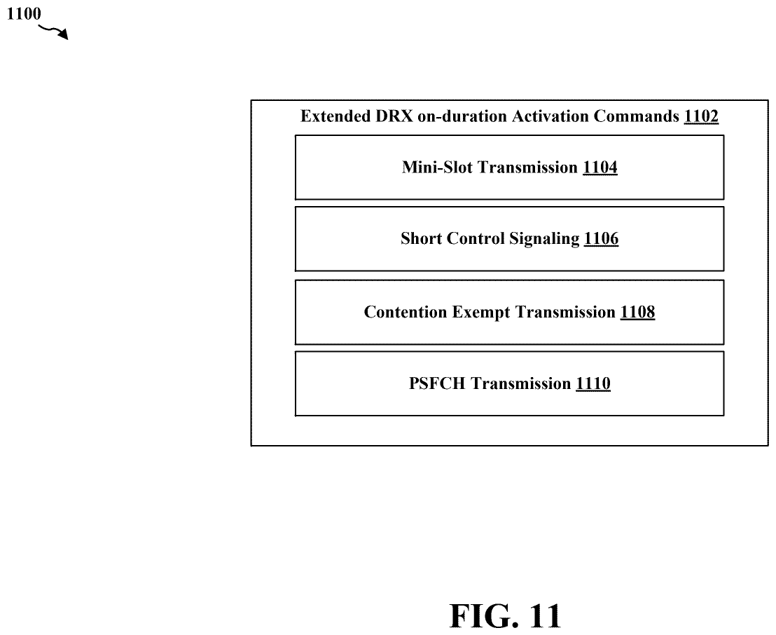

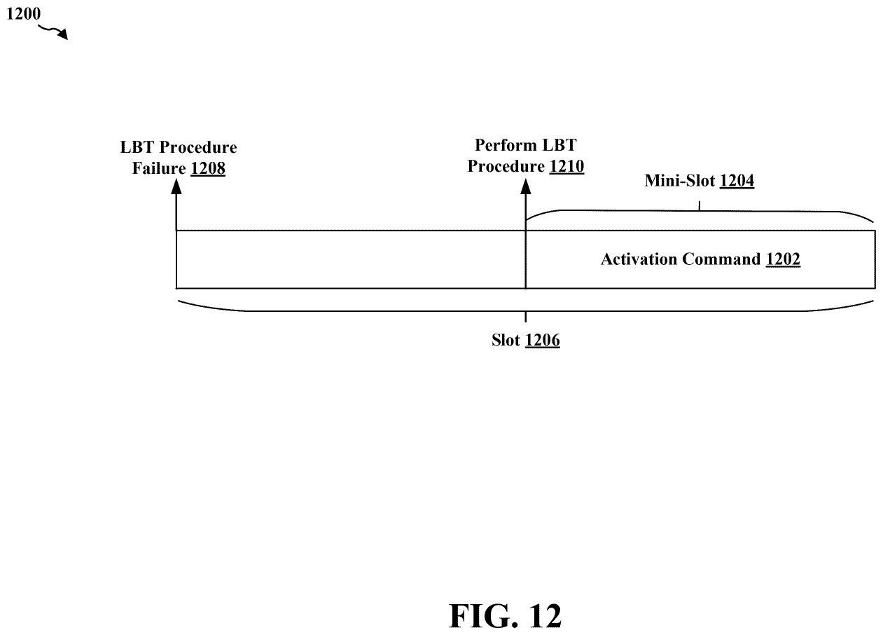

FIG. 11 is a diagram 1100 illustrating examples of extended DRX on-duration activation commands 1102. The extended DRX on-duration activation commands 1102 may include a mini-slot transmission 1104, short control signaling 1106, a contention exempt transmission 1108, or a PSFCH transmission 1110 (described below in FIGS. 12-15, respectively). A Tx UE (e.g., the Tx UE 504) may transmit one or more of the extended DRX on-duration activation commands 1102 to a Rx UE (e.g., the Rx UE 506) in order to activate an extended DRX on-duration (e.g., the extended DRX on-duration 904).

FIG. 12 is a diagram 1200 illustrating an example of an extended DRX on-duration activation command transmitted via a mini-slot transmission. As discussed above, a Tx UE (e.g., the Tx UE 504) may transmit an activation command to a Rx UE (e.g., the Rx UE 506) for activating an extended DRX on-duration (e.g., the extended DRX on-duration 904) if the Tx UE fails an LBT procedure (e.g., the LBT procedure described above in the description of FIG. 7) or if the Tx UE lacks sufficient resources for a transmission during a DRX on-duration (e.g., the DRX on-duration 902). A LBT failure may occur when the Tx UE is not within (i.e., out of) a COT (e.g., the COT 714). A Tx UE resource shortage (i.e., the UE lacks sufficient resources for a transmission during the DRX on-duration) may occur when the Tx UE is within the COT (e.g., the COT 714). Since the Tx UE may be within the COT during a Tx UE resource shortage, the Tx UE may send an activation command via a SCI-2 (e.g., the SCI-2 804) or a MAC control element (MAC-CE) before an end of a last resource associated with the COT.

However, when a Tx UE LBT failure occurs, the Tx UE may not send an activation command before acquiring a COT. In one example, if a Tx UE LBT failure occurs, the Tx UE may transmit an activation command 1202 in a mini-slot 1204 transmission. The activation command 1202 may correspond to the mini-slot transmission 1104. For instance, the Tx UE may attempt to transmit the activation command 1202 in a slot 1206. If the Tx UE fails to transmit the activation command 1202 in the slot 1206, the Tx UE may transmit the activation command in the mini-slot 1204. The activation command 1202 transmitted in the mini-slot 1204 may be transmitted in a SCI-2 (e.g., the SCI-2 804) or a MAC-CE. In an example, a LBT procedure failure 1208 may occur at a time corresponding to a beginning of the slot 1206. The Tx UE may perform a (second) LBT procedure at 1210, where the (second) LBT procedure is performed at a time corresponding to a beginning of the mini-slot 1204. The LBT procedure performed at 1210 may be successfully skipped if a Wi-Fi is near a boundary of the slot 1206, but is terminated before a beginning of a boundary of the mini-slot 1204.

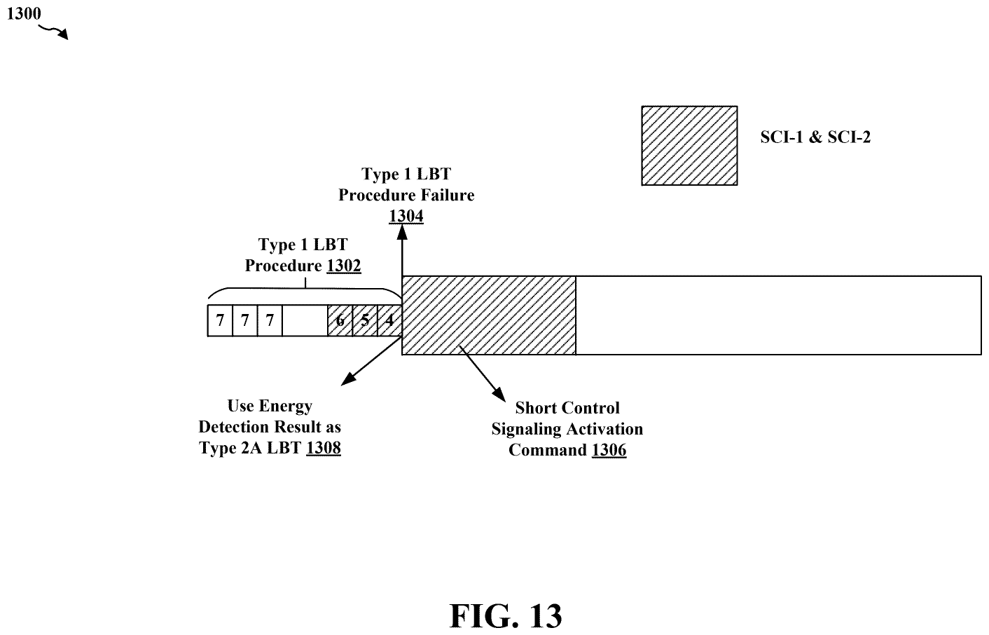

FIG. 13 is a diagram 1300 illustrating an example of an extended DRX on-duration activation command transmitted via short control signaling. Short control signaling may refer to transmissions used by a UE to send management and control frames without sensing a channel for a presence of other signals. Short control signaling may include a contention exempt transmission. Short control signaling may be utilized within an observation period of 50 ms. A number of short control signaling transmissions of a UE may be equal to or less than 50. A total duration of short control signaling of a UE may be less than 2500 μs within the observation period. In an example, a Tx UE (e.g., the Tx UE 504) may attempt to perform a type 1 LBT procedure 1302 in order to transmit data to a Rx UE (e.g., the Rx UE 506). At 1304, the type 1 LBT procedure 1302 may fail. Upon failure of the type 1 LBT procedure 1302, the Tx UE may transmit a short control signaling activation command 1306. The short control signaling activation command 1306 may be associated with a type 2A LBT procedure. At 1308, the Tx UE may utilize an energy detection result associated with the type 2A LBT procedure. The short control signaling activation command 1306 may correspond to the short control signaling 1106.

The short control signaling activation command 1306 may be carried in a SCI-2 (e.g., the SCI-2 804). In one aspect, the SCI-2 may carry control information without carrying other information in order to conform to criteria associated with short control signaling. In such an aspect, the SCI-2 may be in a format associated with activation command transmissions. The Rx UE may receive a SCI-1 (e.g., the SCI-1 802) that indicates the format. When the Rx UE decodes the SCI-1, the Rx UE may determine the format of the SCI-2. Based on the format of the SCI-2 indicated by the SCI-1, the Rx UE may determine whether the SCI-2 is located in a slot or in several symbols.

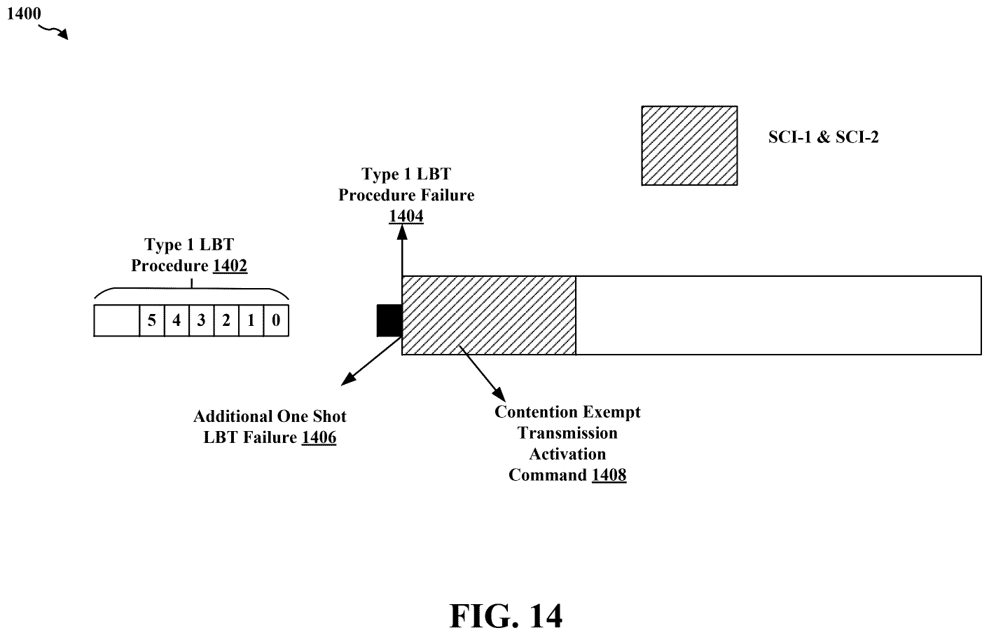

FIG. 14 is a diagram 1400 illustrating an example of an extended DRX on-duration activation command transmitted via a contention exempt transmission. In an example, a Tx UE (e.g., the Tx UE 504) may attempt to perform a type 1 LBT procedure 1402 in order to transmit data to a Rx UE (e.g., the Rx UE 506). At 1404, the type 1 LBT procedure 1402 may fail. For example, the type 1 LBT procedure 1402 may fail based on a counter being greater than zero before a slot boundary. Additionally, an additional one shot LBT may fail at 1406. The Tx UE may not be able to send an activation command via short control signaling associated with a type 2A LBT procedure. The Tx UE may transmit a contention exempt transmission activation command 1408 based on the type 1 LBT failure and the additional one shot LBT failure. The contention exempt transmission activation command 1408 may correspond to the contention exempt transmission 1108.

The contention exempt transmission activation command 1408 may be carried in a SCI-2 (e.g., the SCI-2 804). In one aspect, the SCI-2 may carry control information without carrying other information in order to conform to criteria associated with contention exempt transmission durations. In such an aspect, the SCI-2 may be in a format associated with activation command transmissions. The Rx UE may receive a SCI-1 (e.g., the SCI-1 802) that indicates the format. When the Rx UE decodes the SCI-1, the Rx UE may determine the format of the SCI-2. Based on the format of the SCI-2 indicated by the SCI-1, the Rx UE may determine whether the SCI-2 is located in a slot or in several symbols.

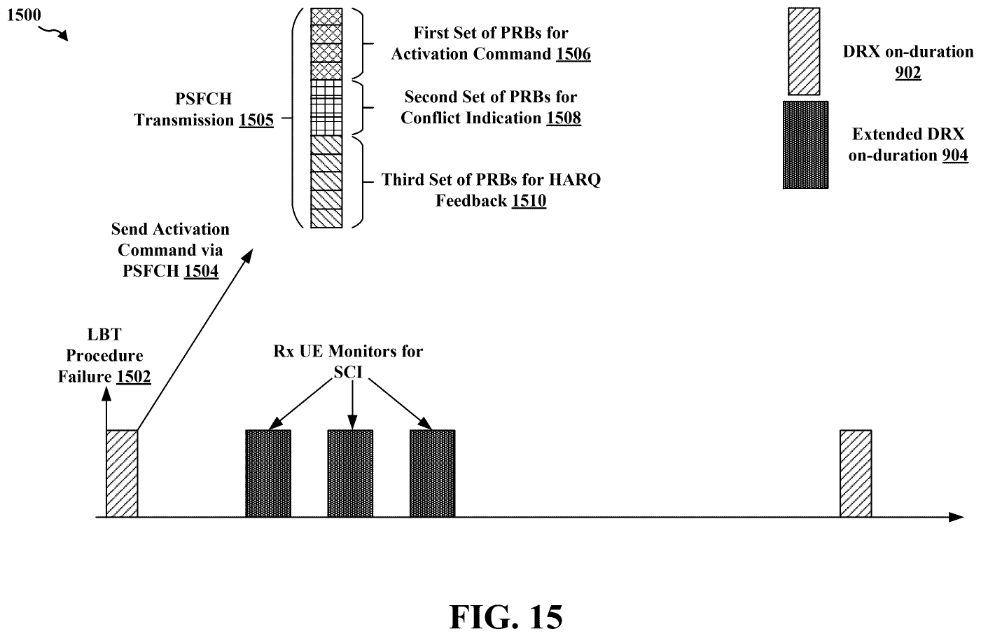

FIG. 15 is a diagram 1500 illustrating an example of an extended DRX on-duration activation command transmitted via a PSFCH transmission 1505. In an example, a Tx UE (e.g., the Tx UE 504) may fail a LBT procedure at 1502. Upon the LBT procedure failing at 1502, the Tx UE may send an activation command at 1504 to a Rx UE (e.g., the Rx UE 506) via the PSFCH transmission 1505. The activation command sent at 1504 may correspond to the PSFCH transmission 1110.

The PSFCH transmission 1505 may include a first set of physical resource blocks (PRBs) 1506 allocated for the activation command, a second set of PRBs 1508 allocated for a conflict indication, and a third set of PRBs 1510 allocated for HARQ feedback. A number of PRBs in a resource pool for the PSFCH transmission 1505 associated with the activation command may be pre-configured or configured via RRC signaling. The Rx UE may attempt to receive the PSFCH transmission 1505 that includes the activation command in a resource pool with PSFCH resources. The activation command to PSFCH mapping may be based on a destination ID (e.g., the destination ID 834) in a SCI-2 (e.g., the SCI-2) corresponding to the Rx UE, i.e., (destination ID) mod N_{activation command}^{PSFCH}.

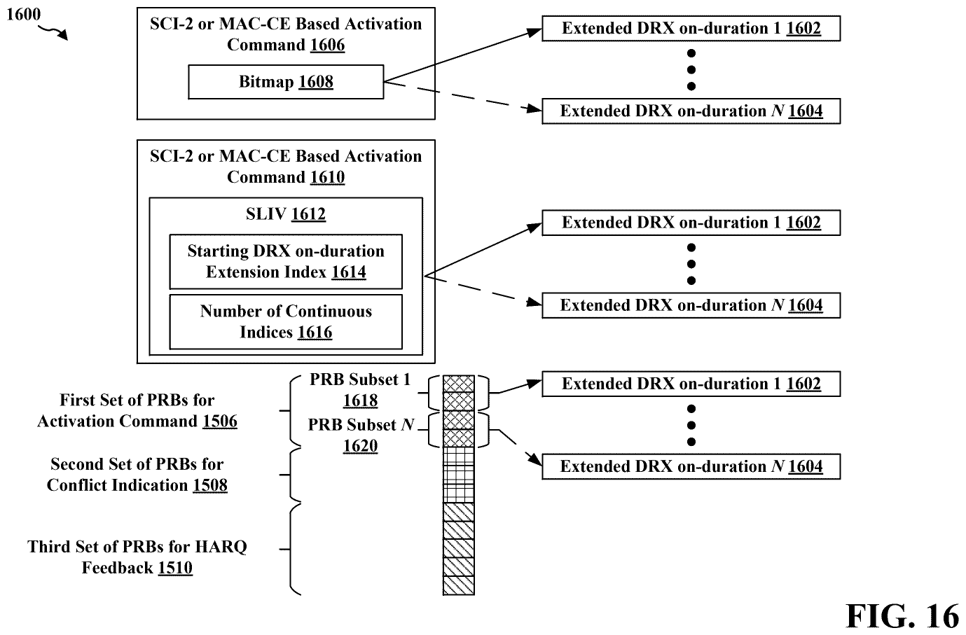

FIG. 16 is a diagram 1600 illustrating examples of indicating extended DRX on-durations for activation. A Tx UE (e.g., the Tx UE 504) may indicate that a first extended DRX on-duration 1602 and/or a Nth extended DRX on-duration 1604 are to be activated for a Rx UE (e.g., the Rx UE 506), where N is a positive integer greater than one (collectively referred to herein as “the plurality of extended DRX on-durations 1602-1604”). In an example, the first extended DRX on-duration 1602 may be associated with a first offset, a first duration, a first cycle length, and a first cycle timer and the Nth extended DRX on-duration 1604 may be associated with a second offset, a second duration, a second cycle length, and a second cycle timer. In a first example, the Tx UE may transmit a SCI-2 or MAC-CE based activation command 1606. The SCI-2 or MAC-CE based activation command 1606 may include a bitmap 1608. The bitmap 1608 may include one or more bits that indicate one or more of the plurality of extended DRX on-durations 1602-1604. The Rx UE may activate the one or more of the plurality of extended DRX on-durations 1602-1604 based on the one or more bits in the bitmap 1608.

In a second example, the Tx UE may transmit a SCI-2 or MAC-CE based activation command 1610. The SCI-2 or MAC-CE based activation command 1610 may include a start and length indicator value (SLIV) 1612. The SLIV 1612 may include an indication of a starting DRX on-duration extension index 1614 and a number of continuous indices 1616. The SLIV 1612 may be for a time domain allocation for a PSSCH. The SLIV 1612 may define a start symbol and a number of consecutive symbols for PSSCH allocation. The Rx UE may activate the one or more of the plurality of extended DRX on-durations 1602-1604 based on the starting DRX on-duration extension index 1614 and the number of continuous indices 1616.

In a third example, a Tx UE may transmit an activation command via the PSFCH transmission 1505. For instance, the activation command may be carried in the first set of physical resource blocks (PRBs) 1506. The Tx UE may partition the first set of PRBs 1506 into a first PRB subset 1618 and a Nth PRB subset 1620 (collectively, “the plurality of PRB subsets 1618-1620”). In an example, the first PRB subset 1618 may correspond to the first extended DRX on-duration 1602 and the Nth PRB subset 1620 may correspond to the Nth extended DRX on-duration 1604. An activation command to PSFCH mapping may be performed in one of the plurality of PRB subsets 1618-1620. In an example, the first PRB subset 1618 may be a “lowest” subset of the plurality of PRB subsets 1618-1620. If the Tx UE is to activate more than one extended DRX on-duration, the Tx UE may send multiple PSFCH transmissions. Activating more than one extended DRX on-duration may be based on capabilities of the Tx UE and/or the Rx UE.

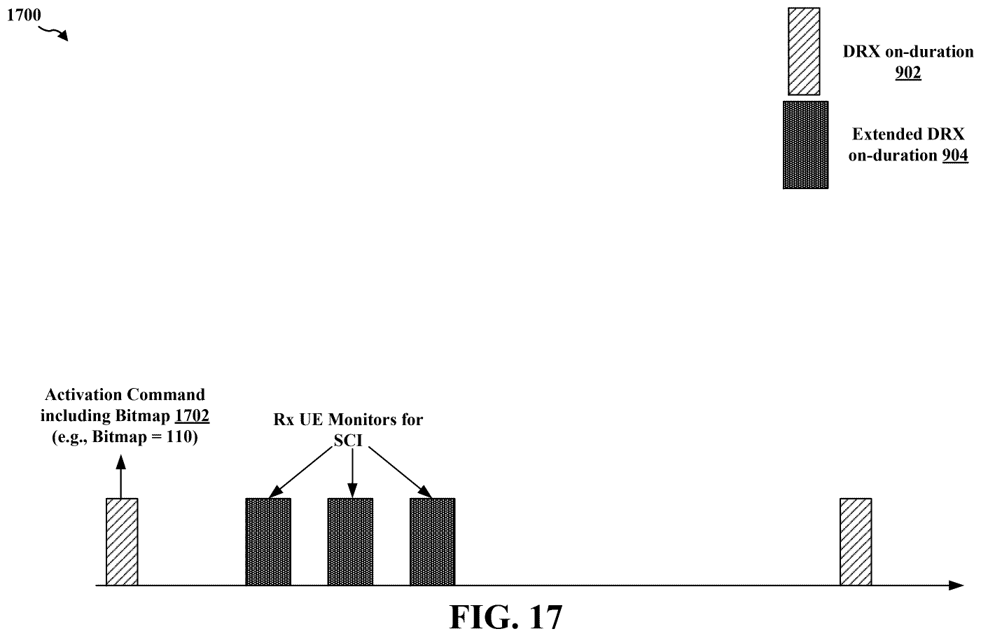

FIG. 17 is a diagram 1700 illustrating an example of indicating an extended DRX on-duration via a bitmap. In an example, a Tx UE (e.g., the Tx UE 504) may transmit an activation command that includes a bitmap at 1702. The activation command may be the SCI-2 or MAC-CE based activation command 1606 and the bitmap may be the bitmap 1608. In an example, the bitmap may include the following bits: “110.” An Rx UE (e.g., the Rx UE 506) may activate one or more of the plurality of extended DRX on-durations 1602-1604 based on the bitmap in the activation command.

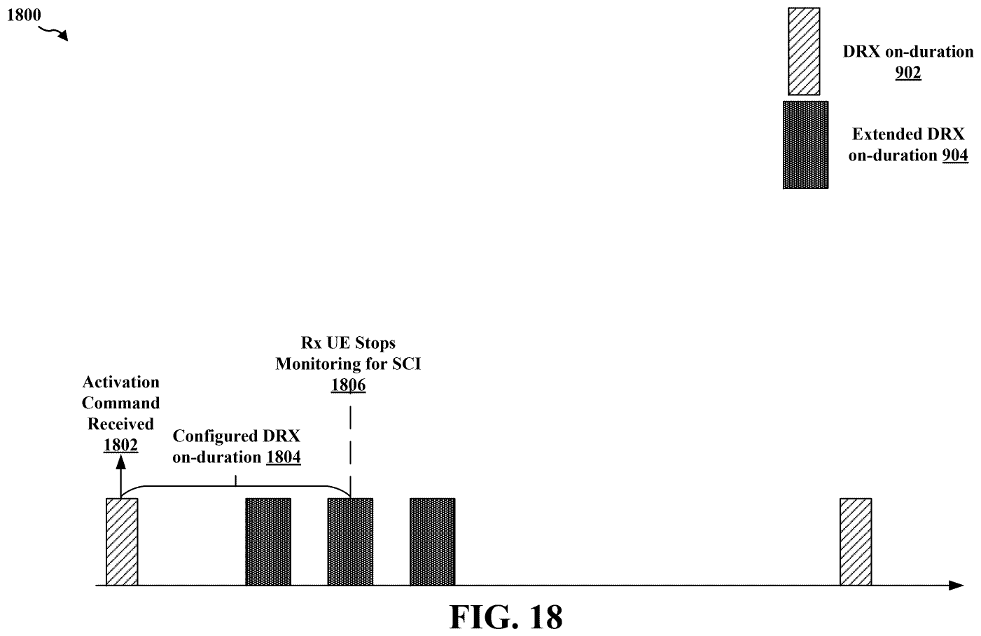

FIG. 18 is a diagram 1800 illustrating an example of determining an extended DRX on-duration based on a remaining DRX on-duration starting from a reception of an activation command. In an example, an activation command (e.g., one of the extended DRX on-duration activation commands 1102) may be received by a Rx UE (e.g., the Rx UE 506) at 1802. The Rx UE may be associated with a configured DRX on-duration 1804. A time spent within an extended DRX on-duration may be based on the configured DRX on-duration and a remaining DRX on-duration that exists when the activation command is received at 1802. Stated differently, the time spent in the extended DRX on-duration may be provided by equation (I) below.

$${T}_{DRX \_ Extension} = {T}_{Configured \_ DRX} - {T}_{activationCommandReceived} \qquad ( I )$$

At 1806, the Rx UE may cease monitoring for a SCI when the extended DRX-on duration expires.

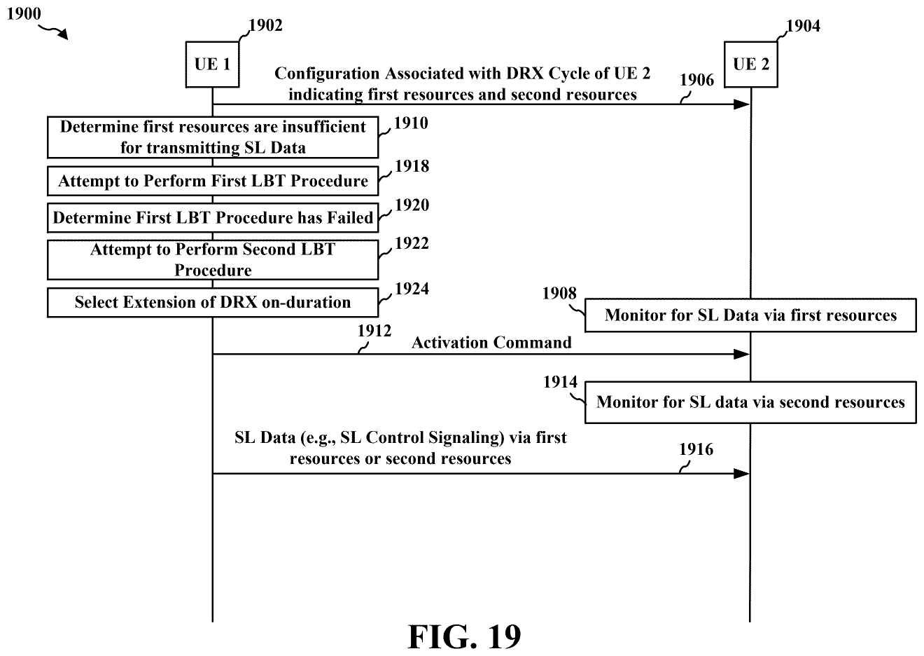

FIG. 19 is a diagram 1900 illustrating example communications between a first UE 1902 and a second UE 1904. In an example, the first UE 1902 may be the Tx UE 504 and the second UE 1904 may be the Rx UE 506.

At 1906, the first UE 1902 may transmit a configuration associated with a DRX cycle of the second UE 1904. The configuration may indicate first resources and second resources (e.g., time and frequency resources). The configuration may also indicate a type of activation command (e.g., one or more of the extended DRX on-duration activation commands 1102). In an example, the first resources may be associated with a DRX on-duration (e.g., the DRX on-duration 902) and the second resources may be associated with an extension of the DRX on-duration (e.g., the extended DRX on-duration 904).

At 1908, the second UE 1904 may monitor for the SL data based on the configuration. In an example, monitoring for the SL data via the first resources may include monitoring for the SL data during a DRX on-duration (e.g., the DRX on-duration 902).

In one aspect, at 1910, the first UE 1902 may determine that the first resources are insufficient for transmitting SL data when the Tx UE is in a COT. In such an aspect, at 1912, the first UE 1902 may transmit an activation command via a SCI-2 (e.g., the SCI-2 804) or a MAC-CE. In such an aspect, at 1914, the second UE 1904 may monitor for the SL data via the second resources. In such an aspect, at 1916, the second UE 1904 may receive SL data (e.g., SL control signaling) via the first resources or the second resources.

In one aspect, at 1918, the first UE 1902 may attempt to perform a first LBT procedure. The first LBT procedure may include aspects described above in connection with the descriptions of FIG. 7, 9, or 12-15. At 1920, the first UE 1902 may determine that the first LBT procedure has failed. At 1922, the first UE 1902 may attempt to perform a second LBT procedure. At 1924, the first UE 1902 may select an extension of a DRX on-duration (e.g., select an extended DRX on-duration characterized by an offset, a duration, a cycle length, and/or a cycle timer). At 1912, the first UE 1902 may transmit an activation command that indicates the extended DRX on-duration. At 1914, the second UE 1904 may monitor for the SL data via the second resources. At 1916, the second UE 1904 may receive SL data (e.g., SL control signaling) via the first resources or the second resources.

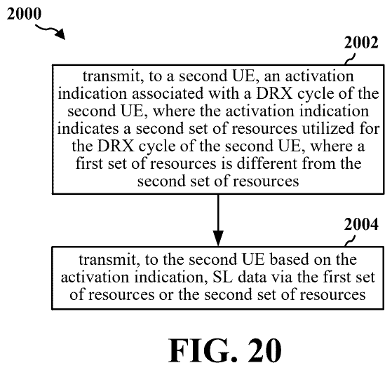

FIG. 20 is a flowchart 2000 of a method of wireless communication. The method may be performed by a first UE (e.g., the UE 104, the UE 350, the Tx UE 504, the first UE 1902, the apparatus 2404). The method may be associated with various advantages at the first UE, such as increased communications reliability with a second UE. For instance, the method may be associated with reduced resource reselections by the first UE. In an example, the method may be performed by the DRX component 198.

At 2002, the first UE transmits, to a second UE, an activation indication associated with a DRX cycle of the second UE, where the activation indication indicates a second set of resources utilized for the DRX cycle of the second UE, where a first set of resources is different from the second set of resources. For example, FIG. 19 at 1912 shows that the first UE 1902 may transmit an activation command (i.e., an activation indication) to the second UE 1904, where the activation command may be associated with a DRX cycle of the second UE 1904. In an example, the DRX cycle of the second UE may be the (long) DRX cycle 404 or the DRX cycles illustrated in FIG. 9. In another example, the first set of resources may be associated with the DRX on-duration 902 and the second set of resources may be associated with the extended DRX on-duration 904. In an example, 2002 may be performed by the DRX component 198.

At 2004, the first UE transmits, to the second UE based on the activation indication, SL data via the first set of resources or the second set of resources. For example, FIG. 19 at 1916 shows that the first UE 1902 may transmit SL data to the second UE 1904 via first resources (i.e., the first set of resources) or second resources (i.e., the second set of resources). In an example, 2004 may be performed by the DRX component 198.

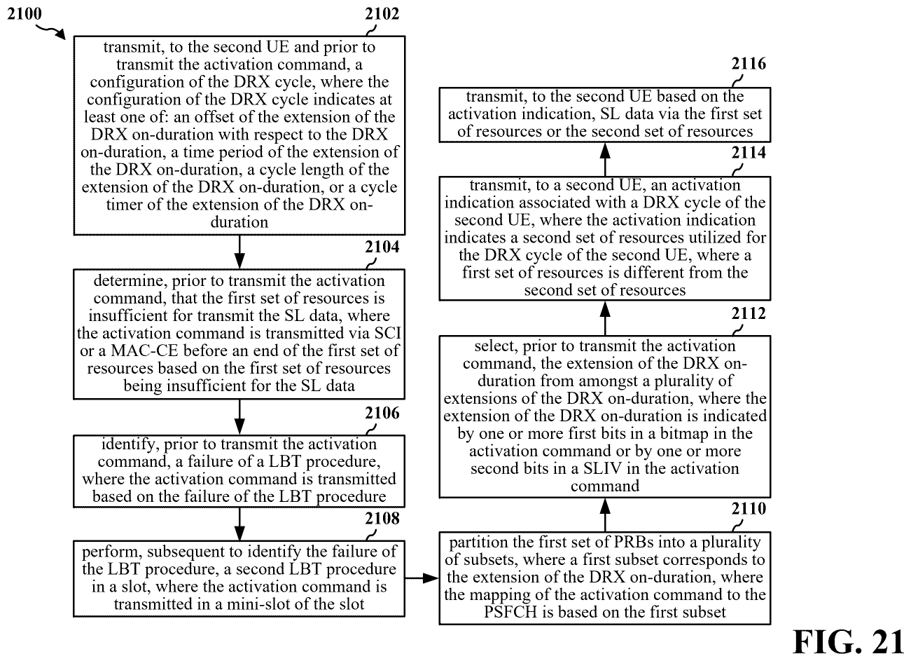

FIG. 21 is a flowchart 2100 of a method of wireless communication. The method may be performed by a first UE (e.g., the UE 104, the UE 350, the Tx UE 504, the first UE 1902, the apparatus 2404). The method may be associated with various advantages at the first UE, such as increased communications reliability with a second UE. For instance, the method may be associated with reduced resource reselections by the first UE. In an example, the method (including the various aspects detailed below) may be performed by the DRX component 198.

At 2114, the first UE transmits, to a second UE, an activation indication associated with a DRX cycle of the second UE, where the activation indication indicates a second set of resources utilized for the DRX cycle of the second UE, where a first set of resources is different from the second set of resources. For example, FIG. 19 at 1912 shows that the first UE 1902 may transmit an activation command (i.e., an activation indication) to the second UE 1904, where the activation command may be associated with a DRX cycle of the second UE 1904. In an example, the DRX cycle of the second UE may be the (long) DRX cycle 404 or the DRX cycles illustrated in FIG. 9. In another example, the first set of resources may be associated with the DRX on-duration 902 and the second set of resources may be associated with the extended DRX on-duration 904. In an example, 2114 may be performed by the DRX component 198.

At 2116, the first UE transmits, to the second UE based on the activation indication, SL data via the first set of resources or the second set of resources. For example, FIG. 19 at 1916 shows that the first UE 1902 may transmit SL data to the second UE 1904 via first resources (i.e., the first set of resources) or second resources (i.e., the second set of resources). In an example, 2116 may be performed by the DRX component 198.

In one aspect, the first set of resources may be associated with a DRX on-duration of the second UE, where the second set of resources may be associated with an extension of the DRX on-duration. For example, the first set of resources may be associated with the DRX on-duration 902 and the second set of resources may be associated with the extended DRX on-duration 904.

In one aspect, the extension of the DRX on-duration may be triggered via the activation indication. For example, FIG. 9 shows that the extended DRX on-duration 904 may be activated at 910 and at 914 based on an explicit indication 909 (i.e., the activation indication).

In one aspect, the second set of resources may be activated based on the activation indication. For example, FIG. 9 shows that resources corresponding to the extended DRX on-duration 904 may be activated at 910 and 914 based on an explicit indication 909.

In one aspect, the activation indication may be an activation command. For example, the activation indication may be one or more of the extended DRX on-duration activation commands 1102. In another example, the activation indication may be the activation command transmitted at 1912.

In one aspect, at 2102, the first UE may transmit, to the second UE and prior to transmitting the activation command, a configuration of the DRX cycle, where the configuration of the DRX cycle may indicate at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration. For example, FIG. 19 at 1906 shows that the first UE 1902 may transmit a configuration to the second UE 1904, where the configuration is associated with a DRX cycle of the second UE 1904 and where the configuration indicates first resources and second resources. In another example, the offset may be the offset 1002, the time period may be the duration 1004, the cycle length may be the cycle length 1006, and the cycle timer may be the cycle timer 1008 illustrated in FIG. 10. In an example, 2102 may be performed by the DRX component 198.

In one aspect, at 2104, the first UE may determine, prior to transmitting the activation command, that the first set of resources is insufficient for transmit the SL data, where the activation command may be transmitted via SCI or a MAC-CE before an end of the first set of resources based on the first set of resources being insufficient for the SL data. For example, FIG. 19 at 1910 shows that the first UE 1902 may determine that first resources are insufficient for transmitting SL data, where the activation command may be transmitted via a SCI or a MAC-CE before an end of the first resources based on the first resources being insufficient for the SL data. In an example, the SCI may include the SCI-1 802 and/or the SCI-2 804. In an example, 2104 may be performed by the DRX component 198.

In one aspect, at 2106, the first UE may identify, prior to transmit the activation command, a failure of a LBT procedure, where the activation command may be transmitted based on the failure of the LBT procedure. For example, FIG. 19 at 1920 shows that the first UE 1902 may determine that a first LBT procedure has failed (i.e., a failure of a LBT procedure). The activation command transmitted at 1912 may be based on the failure of the first LBT procedure at 1920. In another example, the LBT procedure may include aspects described in the first example 702 and/or the second example 712 in FIG. 7. In an example, 2106 may be performed by the DRX component 198.

In one aspect, at 2108, the first UE may perform, subsequent to identify the failure of the LBT procedure, a second LBT procedure in a slot, where the activation command may be transmitted in a mini-slot of the slot. For example, FIG. 19 at 1922 shows that the first UE 1902 may perform a second LBT procedure after identifying the failure of the first LBT procedure at 1920. In an example, the failure of the LBT procedure may correspond to the LBT procedure failure 1208 and the performing the second LBT procedure may correspond to the LBT procedure performed at 1210. In another example, the slot may be the slot 1206, the mini-slot may be the mini-slot 1204, and the activation command may be the activation command 1202. In a further example, the activation command may correspond to the mini-slot transmission 1104. In an example, 2108 may be performed by the DRX component 198.

In one aspect, the LBT procedure may be a type 1 LBT procedure, where the activation command may be transmitted via short control signaling associated with a type 2A LBT procedure. For example, the LBT procedure may be the type 1 LBT procedure 1302 illustrated in FIG. 13. In an example, the activation command may be the short control signaling activation command 1306 illustrated in FIG. 13. In yet another example, the type 2A LBT procedure may be the type 2A LBT procedure depicted in FIG. 13. The type 2A LBT procedure may be associated with characteristics illustrated in the table 722. In a further example, the activation command may correspond to the short control signaling 1106.

In one aspect, the LBT procedure may be a type 1 LBT procedure, where the activation command may be transmitted via a contention exempt transmission. For example, FIG. 14 shows that the LBT procedure may be the type 1 LBT procedure 1402. In another example, the activation command may be the contention exempt transmission activation command 1408. In a further example, the activation command may correspond to the contention exempt transmission 1108.

In one aspect, the activation command may be transmitted via a PSFCH, where a first set of PRBs of the PSFCH may include the activation command, where a second set of PRBs of the PSFCH may include a conflict indication, and where a third set of PRBs of the PSFCH may include a feedback indication, where a mapping of the activation command to the PSFCH may be based on at least on a destination ID corresponding to the second UE. For example, the activation command may be transmitted via the PSFCH transmission 1505. In an example, the first set of PRBs may be the first set of PRBs 1506, the second set of PRBs may be the second set of PRBs 1508, and the third set of PRBs may be the third set of PRBs 1510. In another example, the destination ID corresponding to the second UE may be the destination ID 834. In a further example, the activation command may correspond to the PSFCH transmission 1110.

In one aspect, at 2110, the first UE may partition the first set of PRBs into a plurality of subsets, where a first subset may correspond to the extension of the DRX on-duration, where the mapping of the activation command to the PSFCH may be based on the first subset. For example, FIG. 16 shows that the first set of PRBs 1506 of the PSFCH transmission 1505 may be partitioned into a first PRB subset 1618 and a Nth PRB subset 1620. In an example, the first PRB subset 1618 may correspond to the first extended DRX on-duration 1602. In an example, the mapping of the activation command to the PSFCH may be based on the first PRB subset 1618. In an example, 2110 may be performed by the DRX component 198.

In one aspect, at 2112, the first UE may select, prior to transmit the activation command, the extension of the DRX on-duration from amongst a plurality of extensions of the DRX on-duration, where the extension of the DRX on-duration may be indicated by one or more first bits in a bitmap in the activation command or by one or more second bits in a SLIV in the activation command. For example, FIG. 19 at 1924 shows that the first UE 1902 may select an extension of a DRX on-duration. In another example, the extension of the DRX on-duration may be selected from amongst the plurality of extended DRX on-durations 1602-1604. In a further example, the bitmap may be the bitmap 1608 and the SLIV may be the SLIV 1612. In yet another example, the bitmap may correspond to the bitmap referenced in FIG. 17. In an example, 2112 may be performed by the DRX component 198.

In one aspect, a time period of the extension of the DRX on-duration may be based on a remaining time period of the DRX on-duration when the activation command is transmitted. For example, FIG. 18 illustrates that the time period of the extension of the DRX on-duration may be based on a remaining time period of the DRX on-duration when the activation command is transmitted.

In one aspect, the SL data may be SL control signaling. For example, FIG. 19 at 1916 shows that the SL data may be SL control signaling.

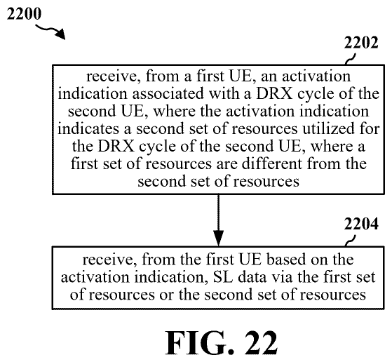

FIG. 22 is a flowchart 2200 of a method of wireless communication. The method may be performed by a second UE (e.g., the UE 104, the UE 350, the Rx UE 506, the second UE 1904, the apparatus 2404). The method may be associated with various advantages at the second UE, such as increased communications reliability with a first UE. In an example, the method may be performed by the DRX component 198.

At 2202, the second UE receives, from a first UE, an activation indication associated with a DRX cycle of the second UE, where the activation indication indicates a second set of resources utilized for the DRX cycle of the second UE, where a first set of resources are different from the second set of resources. For example, FIG. 19 at 1912 shows that the second UE 1904 may receive an activation command (i.e., an activation indication) from the first UE 1902, where the activation command may be associated with a DRX cycle of the second UE 1904. In an example, the DRX cycle of the second UE may be the (long) DRX cycle 404 or the DRX cycles illustrated in FIG. 9. In another example, the first set of resources may be associated with the DRX on-duration 902 and the second set of resources may be associated with the extended DRX on-duration 904. In an example, 2202 may be performed by the DRX component 198.

At 2204, the second UE receives, from the first UE based on the activation indication, SL data via the first set of resources or the second set of resources. For example, FIG. 19 at 1916 shows that the second UE 1904 may receive SL data from the first UE 1902 via first resources (i.e., the first set of resources) or second resources (i.e., the second set of resources). In an example, 2204 may be performed by the DRX component 198.

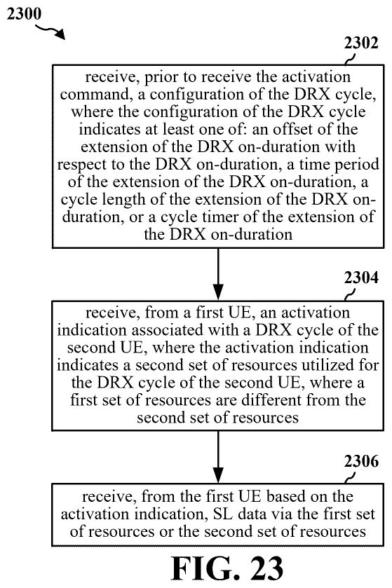

FIG. 23 is a flowchart 2300 of a method of wireless communication. The method may be performed by a second UE (e.g., the UE 104, the UE 350, the Rx UE 506, the second UE 1904, the apparatus 2404). The method may be associated with various advantages at the second UE, such as increased communications reliability with a first UE. In an example, the method (including the various aspects detailed below) may be performed by the DRX component 198.

At 2304, the second UE receives, from a first UE, an activation indication associated with a DRX cycle of the second UE, where the activation indication indicates a second set of resources utilized for the DRX cycle of the second UE, where a first set of resources are different from the second set of resources. For example, FIG. 19 at 1912 shows that the second UE 1904 may receive an activation command (i.e., an activation indication) from the first UE 1902, where the activation command may be associated with a DRX cycle of the second UE 1904. In an example, the DRX cycle of the second UE may be the (long) DRX cycle 404 or the DRX cycles illustrated in FIG. 9. In another example, the first set of resources may be associated with the DRX on-duration 902 and the second set of resources may be associated with the extended DRX on-duration 904. In an example, 2304 may be performed by the DRX component 198.

At 2306, the second UE receives, from the first UE based on the activation indication, SL data via the first set of resources or the second set of resources. For example, FIG. 19 at 1916 shows that the second UE 1904 may receive SL data from the first UE 1902 via first resources (i.e., the first set of resources) or second resources (i.e., the second set of resources). In an example, 2306 may be performed by the DRX component 198.

In one aspect, the first set of resources may be associated with a DRX on-duration of the second UE, where the second set of resources may be associated with an extension of the DRX on-duration. For example, the first set of resources may be associated with the DRX on-duration 902 and the second set of resources may be associated with the extended DRX on-duration 904.

In one aspect, the extension of the DRX on-duration may be triggered via the activation indication. For example, FIG. 9 shows that the extended DRX on-duration 904 may be activated at 910 and at 914 based on an explicit indication 909 (i.e., the activation indication).

In one aspect, the second set of resources may be activated based on the activation indication. For example, FIG. 9 shows that resources corresponding to the extended DRX on-duration 904 may be activated at 910 and 914 based on an explicit indication 909.

In one aspect, the activation indication may be an activation command. For example, the activation indication may be one or more of the extended DRX on-duration activation commands 1102. In another example, the activation indication may be the activation command received at 1912.

In one aspect, at 2302, the second UE may receive, prior to receiving the activation command, a configuration of the DRX cycle, where the configuration of the DRX cycle may indicate at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration. For example, FIG. 19 at 1906 shows that the second UE 1904 may receive a configuration from the first UE 1902, where the configuration is associated with a DRX cycle of the second UE 1904 and where the configuration indicates first resources and second resources. In another example, the offset may be the offset 1002, the time period may be the duration 1004, the cycle length may be the cycle length 1006, and the cycle timer may be the cycle timer 1008 illustrated in FIG. 10. In an example, 2302 may be performed by the DRX component 198.

In one aspect, the activation command may be received via SCI or a MAC-CE before an end of the first set of resources based on the first set of resources being insufficient for the SL data. For example, the activation command received at 1912 may be received via a SCI or a MAC-CE before an end of the first set of resources based on the first set of resources being insufficient for the SL data. In an example, the SCI may include the SCI-1 802 and/or the SCI-2 804.

In one aspect, the activation command may be received based on a failure of a LBT procedure. For example, the activation command received at 1912 may be based on a failure of a LBT procedure. In another example, the LBT procedure may include aspects described in the first example 702 and/or the second example 712 in FIG. 7.

In one aspect, the activation command may be received in a mini-slot of a slot, where the slot may be associated with a second LBT procedure. For example, the activation command may be the activation command 1202, the mini-slot may be the mini-slot 1204, and the slot may be the slot 1206. In a further example, the activation command may correspond to the mini-slot transmission 1104.

In one aspect, the LBT procedure may be a type 1 LBT procedure, where the activation command may be received via short control signaling associated with a type 2A LBT procedure. For example, the LBT procedure may be the type 1 LBT procedure 1302 illustrated in FIG. 13. In an example, the activation command may be the short control signaling activation command 1306 illustrated in FIG. 13. In yet another example, the type 2A LBT procedure may be the type 2A LBT procedure depicted in FIG. 13. The type 2A LBT procedure may be associated with characteristics illustrated in the table 722. In a further example, the activation command may correspond to the short control signaling 1106.

In one aspect, the LBT procedure may be a type 1 LBT procedure, where the activation command may be received via a contention exempt transmission. For example, FIG. 14 shows that the LBT procedure may be the type 1 LBT procedure 1402. In another example, the activation command may be the contention exempt transmission activation command 1408. In a further example, the activation command may correspond to the contention exempt transmission 1108.

In one aspect, the activation command may be received via a PSFCH, where a first set of PRBs of the PSFCH may include the activation command, where a second set of PRBs of the PSFCH may include a conflict indication, and where a third set of PRBs of the PSFCH may include a feedback indication, where a mapping of the activation command to the PSFCH may be based on at least on a destination ID corresponding to the second UE. For example, the activation command may be received via the PSFCH transmission 1505. In an example, the first set of PRBs may be the first set of PRBs 1506, the second set of PRBs may be the second set of PRBs 1508, and the third set of PRBs may be the third set of PRBs 1510. In another example, the destination ID corresponding to the second UE may be the destination ID 834. In a further example, the activation command may correspond to the PSFCH transmission 1110.

In some aspects, the first set of PRBs may be partitioned into a plurality of subsets, where a first subset may correspond to the extension of the DRX on-duration, where the mapping of the activation command to the PSFCH may be based on the first subset. For example, FIG. 16 shows that the first set of PRBs 1506 of the PSFCH transmission 1505 may be partitioned into a first PRB subset 1618 and a Nth PRB subset 1620. In an example, the first PRB subset 1618 may correspond to the first extended DRX on-duration 1602. In an example, the mapping of the activation command to the PSFCH may be based on the first PRB subset 1618.

In one aspect, the extension of the DRX on-duration may be associated with a plurality of extensions of the DRX on-duration, where the extension of the DRX on-duration may be indicated by one or more first bits in a bitmap in the activation command or by one or more second bits in a SLIV in the activation command. For example, the plurality of extensions of the DRX on-duration may be the plurality of extended DRX on-durations 1602-1604. In yet another example, the bitmap may correspond to the bitmap referenced in FIG. 17. In another example, the bitmap may be the bitmap 1608 and the SLIV may be the SLIV 1612.

In one aspect, a time period of the extension of the DRX on-duration may be based on a remaining time period of the DRX on-duration when the activation command is received. For example, FIG. 18 illustrates that the time period of the extension of the DRX on-duration may be based on a remaining time period of the DRX on-duration when the activation command is transmitted.

In one aspect, the SL data may be SL control signaling. For example, FIG. 19 at 1916 shows that the SL data may be SL control signaling.

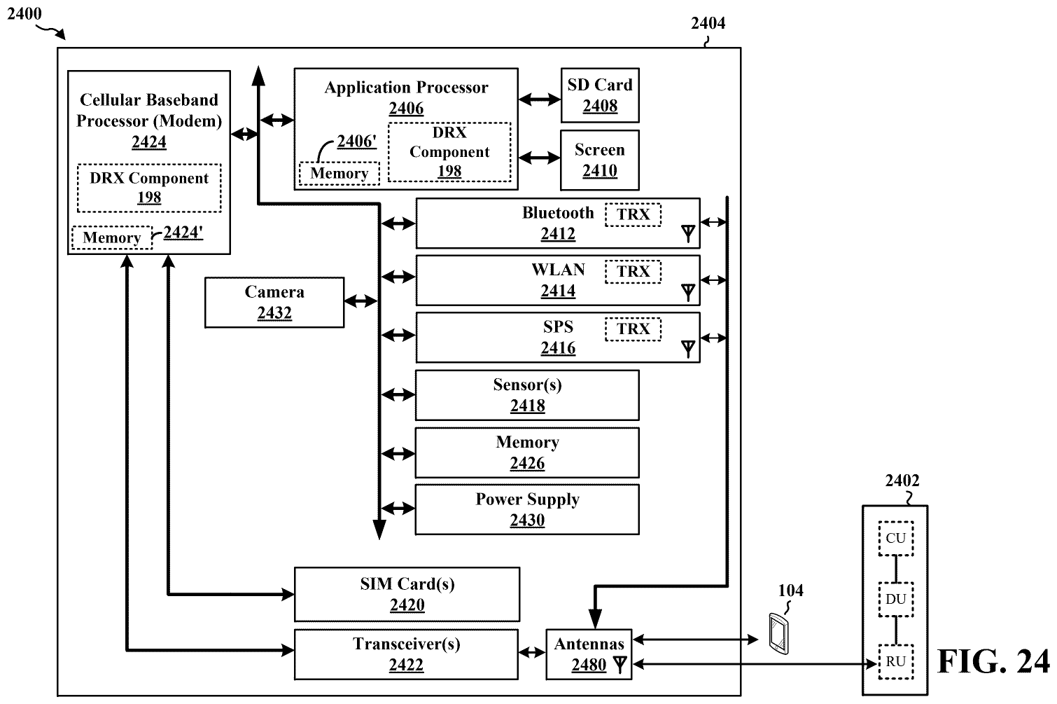

FIG. 24 is a diagram 2400 illustrating an example of a hardware implementation for an apparatus 2404. The apparatus 2404 may be a UE, a component of a UE, or may implement UE functionality. In some aspects, the apparatus 2404 may include a cellular baseband processor 2424 (also referred to as a modem) coupled to one or more transceivers 2422 (e.g., cellular RF transceiver). The cellular baseband processor 2424 may include on-chip memory 2424′. In some aspects, the apparatus 2404 may further include one or more subscriber identity modules (SIM) cards 2420 and an application processor 2406 coupled to a secure digital (SD) card 2408 and a screen 2410. The application processor 2406 may include on-chip memory 2406′. In some aspects, the apparatus 2404 may further include a Bluetooth module 2412, a WLAN module 2414, an SPS module 2416 (e.g., GNSS module), one or more sensor modules 2418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2426, a power supply 2430, and/or a camera 2432. The Bluetooth module 2412, the WLAN module 2414, and the SPS module 2416 may include an on-chip transceiver (TRX) (or in some cases, just a receiver (RX)). The Bluetooth module 2412, the WLAN module 2414, and the SPS module 2416 may include their own dedicated antennas and/or utilize the antennas 2480 for communication. The cellular baseband processor 2424 communicates through the transceiver(s) 2422 via one or more antennas 2480 with the UE 104 and/or with an RU associated with a network entity 2402. The cellular baseband processor 2424 and the application processor 2406 may each include a computer-readable medium/memory 2424′, 2406′, respectively. The additional memory modules 2426 may also be considered a computer-readable medium/memory. Each computer-readable medium/memory 2424′, 2406′, 2426 may be non-transitory. The cellular baseband processor 2424 and the application processor 2406 are each responsible for general processing, including the execution of software stored on the computer-readable medium/memory. The software, when executed by the cellular baseband processor 2424/application processor 2406, causes the cellular baseband processor 2424/application processor 2406 to perform the various functions described supra. The computer-readable medium/memory may also be used for storing data that is manipulated by the cellular baseband processor 2424/application processor 2406 when executing software. The cellular baseband processor 2424/application processor 2406 may be a component of the UE 350 and may include the memory 360 and/or at least one of the TX processor 368, the RX processor 356, and the controller/processor 359. In one configuration, the apparatus 2404 may be a processor chip (modem and/or application) and include just the cellular baseband processor 2424 and/or the application processor 2406, and in another configuration, the apparatus 2404 may be the entire UE (e.g., see 350 of FIG. 3) and include the additional modules of the apparatus 2404.

As discussed supra, the DRX component 198 is configured to transmit, to a second UE, an activation indication associated with a DRX cycle of the second UE, where the activation indication indicates a second set of resources utilized for the DRX cycle of the second UE, where a first set of resources is different from the second set of resources. The DRX component 198 is configured to transmit, to the second UE based on the activation indication, SL data via the first set of resources or the second set of resources. The DRX component 198 is configured to transmit, to the second UE and prior to transmit the activation command, a configuration of the DRX cycle, where the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration. The DRX component 198 is configured to determine, prior to transmit the activation command, that the first set of resources is insufficient for transmit the SL data, where the activation command is transmitted via SCI or a MAC-CE before an end of the first set of resources based on the first set of resources being insufficient for the SL data. The DRX component 198 is configured to identify, prior to transmit the activation command, a failure of a LBT procedure, where the activation command is transmitted based on the failure of the LBT procedure. The DRX component 198 is configured to perform, subsequent to identify the failure of the LBT procedure, a second LBT procedure in a slot, where the activation command is transmitted in a mini-slot of the slot. The DRX component 198 is configured to partition the first set of PRBs into a plurality of subsets, where a first subset corresponds to the extension of the DRX on-duration, where the mapping of the activation command to the PSFCH is based on the first subset. The DRX component 198 is configured to select, prior to transmit the activation command, the extension of the DRX on-duration from amongst a plurality of extensions of the DRX on-duration, where the extension of the DRX on-duration is indicated by one or more first bits in a bitmap in the activation command or by one or more second bits in a SLIV in the activation command. The DRX component 198 is configured to receive, from a first UE, an activation indication associated with a DRX cycle of the second UE, where the activation indication indicates a second set of resources utilized for the DRX cycle of the second UE, where a first set of resources are different from the second set of resources. The DRX component 198 is configured to receive, from the first UE based on the activation indication, SL data via the first set of resources or the second set of resources. The DRX component 198 is configured to receive, prior to receive the activation command, a configuration of the DRX cycle, where the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration. The DRX component 198 may be within the cellular baseband processor 2424, the application processor 2406, or both the cellular baseband processor 2424 and the application processor 2406. The DRX component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2404 may include a variety of components configured for various functions. In one configuration, the apparatus 2404, and in particular the cellular baseband processor 2424 and/or the application processor 2406, includes means for transmitting, to a second UE, an activation indication associated with a DRX cycle of the second UE, where the activation indication indicates a second set of resources utilized for the DRX cycle of the second UE, where a first set of resources is different from the second set of resources. In one configuration, the apparatus 2404, and in particular the cellular baseband processor 2424 and/or the application processor 2406, includes means for transmitting, to the second UE based on the activation indication, SL data via the first set of resources or the second set of resources. In one configuration, the apparatus 2404, and in particular the cellular baseband processor 2424 and/or the application processor 2406, includes means for transmitting, to the second UE and prior to transmitting the activation command, a configuration of the DRX cycle, where the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration. In one configuration, the apparatus 2404, and in particular the cellular baseband processor 2424 and/or the application processor 2406, includes means for determining, prior to transmitting the activation command, that the first set of resources is insufficient for transmitting the SL data, where the activation command is transmitted via SCI or a MAC-CE before an end of the first set of resources based on the first set of resources being insufficient for the SL data. In one configuration, the apparatus 2404, and in particular the cellular baseband processor 2424 and/or the application processor 2406, includes means for identifying, prior to transmitting the activation command, a failure of a LBT procedure, where the activation command is transmitted based on the failure of the LBT procedure. In one configuration, the apparatus 2404, and in particular the cellular baseband processor 2424 and/or the application processor 2406, includes means for performing, subsequent to identifying the failure of the LBT procedure, a second LBT procedure in a slot, where the activation command is transmitted in a mini-slot of the slot. In one configuration, the apparatus 2404, and in particular the cellular baseband processor 2424 and/or the application processor 2406, includes means for partitioning the first set of PRBs into a plurality of subsets, where a first subset corresponds to the extension of the DRX on-duration, where the mapping of the activation command to the PSFCH is based on the first subset. In one configuration, the apparatus 2404, and in particular the cellular baseband processor 2424 and/or the application processor 2406, includes means for selecting, prior to transmitting the activation command, the extension of the DRX on-duration from amongst a plurality of extensions of the DRX on-duration, where the extension of the DRX on-duration is indicated by one or more first bits in a bitmap in the activation command or by one or more second bits in a SLIV in the activation command. In one configuration, the apparatus 2404, and in particular the cellular baseband processor 2424 and/or the application processor 2406, includes means for receiving, from a first UE, an activation indication associated with a DRX cycle of the second UE, where the activation indication indicates a second set of resources utilized for the DRX cycle of the second UE, where a first set of resources are different from the second set of resources. In one configuration, the apparatus 2404, and in particular the cellular baseband processor 2424 and/or the application processor 2406, includes means for receiving, from the first UE based on the activation indication, SL data via the first set of resources or the second set of resources. In one configuration, the apparatus 2404, and in particular the cellular baseband processor 2424 and/or the application processor 2406, includes means for receiving, prior to receiving the activation command, a configuration of the DRX cycle, where the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration. The means may be the DRX component 198 of the apparatus 2404 configured to perform the functions recited by the means. As described supra, the apparatus 2404 may include the TX processor 368, the RX processor 356, and the controller/processor 359. As such, in one configuration, the means may be the TX processor 368, the RX processor 356, and/or the controller/processor 359 configured to perform the functions recited by the means.

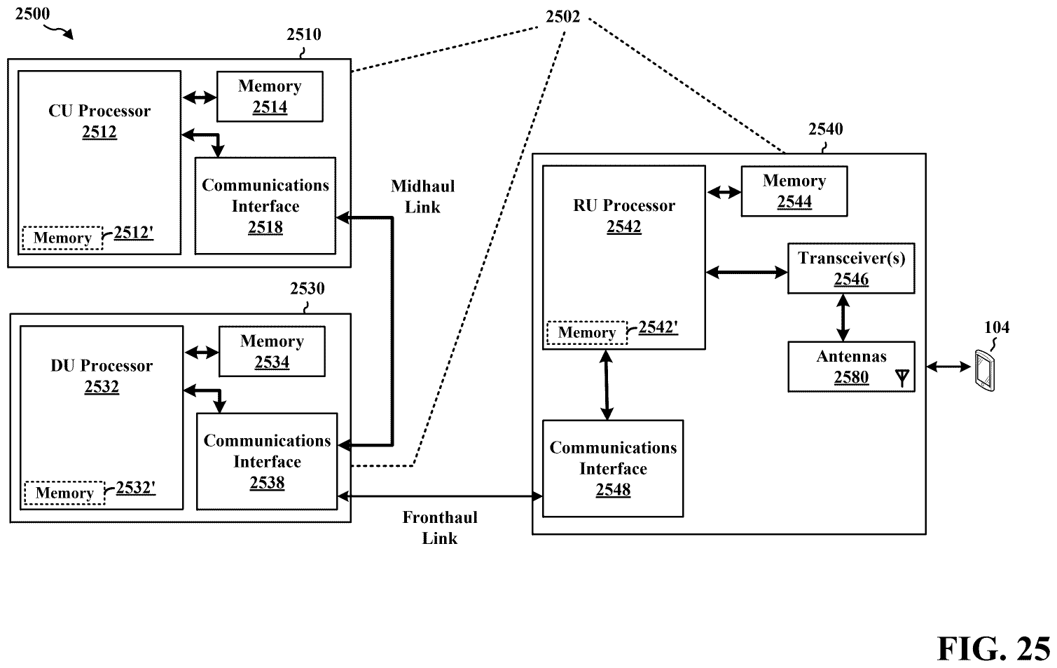

FIG. 25 is a diagram 2500 illustrating an example of a hardware implementation for a network entity 2502. The network entity 2502 may be a BS, a component of a BS, or may implement BS functionality. The network entity 2502 may include at least one of a CU 2510, a DU 2530, or an RU 2540. The network entity 2502 may include the CU 2510; both the CU 2510 and the DU 2530; each of the CU 2510, the DU 2530, and the RU 2540; the DU 2530; both the DU 2530 and the RU 2540; or the RU 2540. The CU 2510 may include a CU processor 2512. The CU processor 2512 may include on-chip memory 2512′. In some aspects, the CU 2510 may further include additional memory modules 2514 and a communications interface 2518. The CU 2510 communicates with the DU 2530 through a midhaul link, such as an F1 interface. The DU 2530 may include a DU processor 2532. The DU processor 2532 may include on-chip memory 2532′. In some aspects, the DU 2530 may further include additional memory modules 2534 and a communications interface 2538. The DU 2530 communicates with the RU 2540 through a fronthaul link. The RU 2540 may include an RU processor 2542. The RU processor 2542 may include on-chip memory 2542′. In some aspects, the RU 2540 may further include additional memory modules 2544, one or more transceivers 2546, antennas 2580, and a communications interface 2548. The RU 2540 communicates with the UE 104. The on-chip memory 2512′, 2532′, 2542′ and the additional memory modules 2514, 2534, 2544 may each be considered a computer-readable medium/memory. Each computer-readable medium/memory may be non-transitory. Each of the processors 2512, 2532, 2542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As noted above, a UE may utilize a C-DRX cycle for sidelink communications in order to conserve power. When a physical layer is indicated within an active time of an Rx UE from a medium access control (MAC) layer for candidate resource selection, a restriction may be applied in a physical layer such that at least a subset of candidate resources reported to the MAC layer may be located within an indicated active time of the Rx UE. If the candidate resources are not within an active time of the Rx UE, the Rx UE may add at least one resource within the active time (e.g., based on an implementation of the Rx UE). In unlicensed band sidelink (SL-U), a UE may perform a LBT procedure before transmission. In an example, the UE may first select a set of resources (e.g., time and frequency resources) and the UE may then fail the LBT procedure, which may trigger a LBT failure at a MAC layer of the UE. The UE may handle the LBT failure in different manners. In a first example, the UE may handle the LBT failure by issuing a resource reselection at the MAC layer. In a second example, the UE may handle the LBT failure by using a retransmission occasion for an initial transmission. If C-DRX is used in SL-U, resources selected by a UE implementation may be affected by interference. As a result, a probability of a failure of a LBT procedure may be higher. Furthermore, frequent resource reselection and/or insufficient resources may impede throughput at the UE.

Various technologies pertaining to enhancing a sidelink DRX cycle are described herein. In an example, a first UE transmits, to a second UE, an activation indication associated with a DRX cycle of the second UE, where the activation indication indicates a second set of resources (e.g., resources associated with an extension of the DRX on-duration of the second UE) utilized for the DRX cycle of the second UE, where a first set of resources (e.g., resources associated with a DRX on-duration of the second UE) is different from the second set of resources. The first UE transmits, to the second UE based on the activation indication, SL data via the first set of resources or the second set of resources. Vis-à-vis the activation indication, the above-described technologies may increase communications reliability between the first UE and the second UE. For instance, the activation indication may reduce occurrences of resource reselection at a MAC layer and/or may reduce use of retransmission occasions for initial transmissions. The activation indication may also reduce a probability of a LBT failure via reduced resource reselection.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first UE, including: transmitting, to a second UE, an activation indication associated with a DRX cycle of the second UE, where the activation indication indicates a second set of resources utilized for the DRX cycle of the second UE, where a first set of resources is different from the second set of resources; and transmitting, to the second UE based on the activation indication, SL data via the first set of resources or the second set of resources.

Aspect 2 is the method of aspect 1, where the first set of resources is associated with a DRX on-duration of the second UE, where the second set of resources is associated with an extension of the DRX on-duration.

Aspect 3 is the method of aspect 2, where the extension of the DRX on-duration is triggered via the activation indication.

Aspect 4 is the method of aspect 3, where the second set of resources is activated based on the activation indication.

Aspect 5 is the method of any of aspects 2-4, where the activation indication is an activation command.

Aspect 6 is the method of aspect 5, further including: transmitting, to the second UE and prior to transmitting the activation command, a configuration of the DRX cycle, where the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration.

Aspect 7 is the method of any of aspects 5-6, further including: determining, prior to transmitting the activation command, that the first set of resources is insufficient for transmitting the SL data, where the activation command is transmitted via SCI or a MAC-CE before an end of the first set of resources based on the first set of resources being insufficient for the SL data.

Aspect 8 is the method of any of aspects 5-6, further including: identifying, prior to transmitting the activation command, a failure of a LBT procedure, where the activation command is transmitted based on the failure of the LBT procedure.

Aspect 9 is the method of aspect 8, further including: performing, subsequent to identifying the failure of the LBT procedure, a second LBT procedure in a slot, where the activation command is transmitted in a mini-slot of the slot.

Aspect 10 is the method of aspect 8, where the LBT procedure is a type 1 LBT procedure, where the activation command is transmitted via short control signaling associated with a type 2A LBT procedure.

Aspect 11 is the method of aspect 8, where the LBT procedure is a type 1 LBT procedure, where the activation command is transmitted via a contention exempt transmission.

Aspect 12 is the method of aspect 8, where the activation command is transmitted via a PSFCH, where a first set of PRBs of the PSFCH includes the activation command, where a second set of PRBs of the PSFCH includes a conflict indication, and where a third set of PRBs of the PSFCH includes a feedback indication, where a mapping of the activation command to the PSFCH is based on at least on a destination ID corresponding to the second UE.

Aspect 13 is the method of aspect 12, further including: partitioning the first set of PRBs into a plurality of subsets, where a first subset corresponds to the extension of the DRX on-duration, where the mapping of the activation command to the PSFCH is based on the first subset.

Aspect 14 is the method of any of aspects 5-11, further including: selecting, prior to transmitting the activation command, the extension of the DRX on-duration from amongst a plurality of extensions of the DRX on-duration, where the extension of the DRX on-duration is indicated by one or more first bits in a bitmap in the activation command or by one or more second bits in a SLIV in the activation command.

Aspect 15 is the method of any of aspects 5-14, where a time period of the extension of the DRX on-duration is based on a remaining time period of the DRX on-duration when the activation command is transmitted.

Aspect 16 is the method of any of aspects 1-15, where the SL data is SL control signaling.

Aspect 17 is an apparatus for wireless communication at a first UE including a memory and at least one processor coupled to the memory and based at least in part on information stored in the memory, the at least one processor is configured to perform a method in accordance with any of aspects 1-16.

Aspect 18 is an apparatus for wireless communications, including means for performing a method in accordance with any of aspects 1-16.

Aspect 19 is the apparatus of aspect 17 or 18 further including at least one of a transceiver or an antenna coupled to the at least one processor, where the at least one processor is configured to transmit the SL data via at least one of the transceiver or the antenna.

Aspect 20 is a computer-readable medium (e.g., a non-transitory computer-readable medium) including instructions that, when executed by an apparatus, cause the apparatus to perform a method in accordance with any of aspects 1-16.

Aspect 21 is a method of wireless communication at a second UE, including: receiving, from a first UE, an activation indication associated with a DRX cycle of the second UE, where the activation indication indicates a second set of resources utilized for the DRX cycle of the second UE, where a first set of resources are different from the second set of resources; and receiving, from the first UE based on the activation indication, SL data via the first set of resources or the second set of resources.

Aspect 22 is the method of aspect 21, where the first set of resources is associated with a DRX on-duration of the second UE, where the second set of resources is associated with an extension of the DRX-on duration.

Aspect 23 is the method of aspect 22, where the extension of the DRX on-duration is triggered via the activation indication.

Aspect 24 is the method of aspect 23, where the second set of resources is activated based on the activation indication.

Aspect 25 is the method of any of aspects 22-24, where the activation indication is an activation command.

Aspect 26 is the method of aspect 25, further including: receiving, prior to receiving the activation command, a configuration of the DRX cycle, where the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration.

Aspect 27 is the method of any of aspects 25-26, where the activation command is received via SCI or a MAC-CE before an end of the first set of resources based on the first set of resources being insufficient for the SL data.

Aspect 28 is the method of any of aspects 25-26, where the activation command is received based on a failure of a LBT procedure.

Aspect 29 is the method of aspect 28, where the activation command is received in a mini-slot of a slot, where the slot is associated with a second LBT procedure.

Aspect 30 is the method of aspect 28, where the LBT procedure is a type 1 LBT procedure, where the activation command is received via short control signaling associated with a type 2A LBT procedure.

Aspect 31 is the method of aspect 28, where the LBT procedure is a type 1 LBT procedure, where the activation command is received via a contention exempt transmission.

Aspect 32 is the method of aspect 28, where the activation command is received via a PSFCH, where a first set of PRBs of the PSFCH includes the activation command, where a second set of PRBs of the PSFCH includes a conflict indication, and where a third set of PRBs of the PSFCH includes a feedback indication, where a mapping of the activation command to the PSFCH is based on at least on a destination ID corresponding to the second UE.

Aspect 33 is the method of aspect 32, where the first set of PRBs is partitioned into a plurality of subsets, where a first subset corresponds to the extension of the DRX on-duration, where the mapping of the activation command to the PSFCH is based on the first subset.

Aspect 34 is the method of any of aspects 25-31, where the extension of the DRX on-duration is associated with a plurality of extensions of the DRX on-duration, where the extension of the DRX on-duration is indicated by one or more first bits in a bitmap in the activation command or by one or more second bits in a SLIV in the activation command.

Aspect 35 is the method of any of aspects 25-34, where a time period of the extension of the DRX on-duration is based on a remaining time period of the DRX on-duration when the activation command is received.

Aspect 36 is the method of any of aspects 21-35, where the SL data is SL control signaling.

Aspect 37 is an apparatus for wireless communication at a second UE including a memory and at least one processor coupled to the memory and based at least in part on information stored in the memory, the at least one processor is configured to perform a method in accordance with any of aspects 21-36.

Aspect 38 is an apparatus for wireless communications, including means for performing a method in accordance with any of aspects 21-36.

Aspect 39 is the apparatus of aspect 37 or 38 further including at least one of a transceiver or an antenna coupled to the at least one processor, where the at least one processor is configured to receive the SL data via at least one of the transceiver or the antenna.

Aspect 40 is a computer-readable medium (e.g., a non-transitory computer-readable medium) including instructions that, when executed by an apparatus, cause the apparatus to perform a method in accordance with any of aspects 21-36.

1. An apparatus for wireless communication at a first user equipment (UE), comprising:
a memory; and
at least one processor coupled to the memory and, based at least in part on information stored in the memory, the at least one processor is configured to:
transmit, to a second UE, an activation indication associated with a discontinuous reception (DRX) cycle of the second UE, wherein the activation indication indicates a second set of resources utilized for the DRX cycle of the second UE, wherein a first set of resources is different from the second set of resources; and
transmit, to the second UE based on the activation indication, sidelink (SL) data via the first set of resources or the second set of resources.

2. The apparatus of claim 1, wherein the first set of resources is associated with a DRX on-duration of the second UE, wherein the second set of resources is associated with an extension of the DRX on-duration.

3. The apparatus of claim 2, wherein the extension of the DRX on-duration is configured to be triggered via the activation indication.

4. (canceled)

5. The apparatus of claim 2, wherein the activation indication is an activation command.

6. The apparatus of claim 5, wherein the at least one processor is further configured to:
transmit, to the second UE and prior to the at least one processor being configured to transmit the activation command, a configuration of the DRX cycle, wherein the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration.

7. The apparatus of claim 5, wherein the at least one processor is further configured to:
determine, prior to the at least one processor being configured transmit the activation command, that the first set of resources is insufficient for transmit the SL data, wherein to transmit the activation command, the at least one processor is configured to transmit the activation command via sidelink control information (SCI) or a medium access control (MAC) control element (MAC-CE) before an end of the first set of resources based on the first set of resources being insufficient for the SL data.

8. The apparatus of claim 5, wherein the at least one processor is further configured to:
identify, prior to the at least one processor being configured to transmit the activation command, a failure of a listen-before-talk (LBT) procedure, wherein to transmit the activation command, the at least one processor is configured to transmit the activation command based on the failure of the LBT procedure.

9. The apparatus of claim 8, wherein the at least one processor is further configured to:
perform, subsequent to the at least one processor being configured to identify the failure of the LBT procedure, a second LBT procedure in a slot, wherein to transmit the activation command, the at least one processor is configured to transmit the activation command in a mini-slot of the slot.

10. The apparatus of claim 8, wherein the LBT procedure is a type 1 LBT procedure, wherein to transmit the activation command, the at least one processor is configured to transmit the activation command via short control signaling associated with a type 2A LBT procedure or via a contention exempt transmission.

11. (canceled)

12. The apparatus of claim 8, wherein to transmit the activation command, the at least one processor is configured to transmit the activation command via a physical sidelink feedback channel (PSFCH), wherein a first set of physical resource blocks (PRBs) of the PSFCH includes the activation command, wherein a second set of PRBs of the PSFCH includes a conflict indication, and wherein a third set of PRBs of the PSFCH includes a feedback indication, wherein a mapping of the activation command to the PSFCH is based on at least on a destination ID corresponding to the second UE.

13. The apparatus of claim 12, wherein the at least one processor is further configured to:
partition the first set of PRBs into a plurality of subsets, wherein a first subset corresponds to the extension of the DRX on-duration, wherein the mapping of the activation command to the PSFCH is based on the first subset.

14. The apparatus of claim 5, wherein the at least one processor is further configured to:
select, prior to the at least one processor being configured to transmit the activation command, the extension of the DRX on-duration from amongst a plurality of extensions of the DRX on-duration, wherein the extension of the DRX on-duration is configured to be indicated by one or more first bits in a bitmap in the activation command or by one or more second bits in a start and length indicator (SLIV) in the activation command.

15. The apparatus of claim 5, wherein a time period of the extension of the DRX on-duration is based on a remaining time period of the DRX on-duration when the at least one processor is configured to transmit the activation command.

16. (canceled)

17. A method of wireless communication at a first user equipment (UE), comprising:
transmitting, to a second UE, an activation indication associated with a discontinuous reception (DRX) cycle of the second UE, wherein the activation indication indicates a second set of resources utilized for the DRX cycle of the second UE, wherein a first set of resources is different from the second set of resources; and
transmitting, to the second UE based on the activation indication, sidelink (SL) data via the first set of resources or the second set of resources.

18. An apparatus for wireless communication at a second user equipment (UE), comprising:
a memory; and
at least one processor coupled to the memory and, based at least in part on information stored in the memory, the at least one processor is configured to:
receive, from a first UE, an activation indication associated with a discontinuous reception (DRX) cycle of the second UE, wherein the activation indication indicates a second set of resources utilized for the DRX cycle of the second UE, wherein a first set of resources are different from the second set of resources; and
receive, from the first UE based on the activation indication, sidelink (SL) data via the first set of resources or the second set of resources.

19. The apparatus of claim 18, wherein the first set of resources is associated with a DRX on-duration of the second UE, wherein the second set of resources is associated with an extension of the DRX on-duration.

20. (canceled)

21. (canceled)

22. The apparatus of claim 19, wherein the activation indication is an activation command.

23. The apparatus of claim 22, wherein the at least one processor is further configured to:
receive, prior to the at least one processor being configured to receive the activation command, a configuration of the DRX cycle, wherein the configuration of the DRX cycle indicates at least one of: an offset of the extension of the DRX on-duration with respect to the DRX on-duration, a time period of the extension of the DRX on-duration, a cycle length of the extension of the DRX on-duration, or a cycle timer of the extension of the DRX on-duration.

24. The apparatus of claim 22, wherein to receive the activation command, the at least one processor is configured to receive the activation command via sidelink control information (SCI) or a medium access control (MAC) control element (MAC-CE) before an end of the first set of resources based on the first set of resources being insufficient for the SL data.

25. The apparatus of claim 22, wherein to receive the activation command, the at least one processor is configured to receive the activation command based on a failure of a listen-before-talk (LBT) procedure.

26. (canceled)

27. (canceled)

28. (canceled)

29. (canceled)

30. (canceled)
